(19) United States
(12) Patent Application Publication
(10) Pub. No.: US 2016/0269104 A1
(43) Pub. Date: Sep. 15, 2016

(54) DOWNLINK SIGNAL TRANSMISSION/RECEPTION METHOD IN WIRELESS COMMUNICATION SYSTEM AND APPARATUS FOR SAME

(71) Applicant: LG ELECTRONICS INC., Yeongdeungpo-gu, Seoul (KR)

(72) Inventors: Seungmin LEE, Seoul (KR); Suckchel YANG, Seoul (KR); Hanbyul SEO, Seoul (KR); Inkwon SEO, Seoul (KR)

(73) Assignee: LG ELECTRONICS INC., Seoul (KR)

(21) Appl. No.: 15/029,520

(22) PCT Filed: Nov. 7, 2014
(86) PCT No.: PCT/KR2014/010696

§ 371 Date: Apr. 14, 2016

Related U.S. Application Data
(60) Provisional application No. 61/901,421, filed on Nov. 7, 2013.
(60) Provisional application No. 61/926,381, filed on Jan. 12, 2014.
(60) Provisional application No. 61/926,947, filed on Jan. 13, 2014.
(60) Provisional application No. 61/927,979, filed on Jan. 15, 2014.
(60) Provisional application No. 61/930,947, filed on Jan. 24, 2014.
(60) Provisional application No. 61/932,761, filed on Jan. 28, 2014.
(60) Provisional application No. 61/933,297, filed on Jan. 29, 2014.
(60) Provisional application No. 61/971,517, filed on Mar. 27, 2014.
(60) Provisional application No. 61/986,120, filed on Apr. 30, 2014.

(51) Int. Cl. H04B 7/26; H04L 5/14; H04L 1/18; H04L 29/12; H04J 11/00; H04H 20/38; H04W 72/04; H04W 76/04

(52) U.S. Cl. CPC H04B 7/2656; H04W 72/042; H04W 72/0413; H04L 5/14; H04W 76/046; H04L 61/6022; H04J 11/00; H04H 20/38; H04L 1/1812; H04W 88/16

(57) ABSTRACT

The present invention relates to a method and an apparatus for receiving a downlink signal by a user equipment in a time division duplex (TDD) wireless communication system that supports a change of use of wireless resources. Particularly, the method comprises the steps of: configuring a first uplink-downlink configuration and a second uplink-downlink configuration for the user equipment; and receiving downlink control information including a particular field, wherein the particular field is defined as an independent state for each of the first uplink-downlink configuration and the second uplink-downlink configuration.

### TECHNICAL FIELD

The present invention relates to a wireless communication system and, more particularly, to a method of transmitting and receiving a downlink signal in a wireless communication system and an apparatus therefor.

### BACKGROUND ART

A 3rd generation partnership project long term evolution (3GPP LTE) (hereinafter, referred to as ‘LIE’) communication system which is an example of a wireless communication system to which the present invention can be applied will be described in brief.

FIG. 1 is a diagram illustrating a network structure of an Evolved Universal Mobile Telecommunications System (E-UMTS) which is an example of a wireless communication system. The E-UMTS is an evolved version of the conventional UMTS, and its basic standardization is in progress under the 3rd Generation Partnership Project (3GPP). The E-UMTS may be referred to as a Long Term Evolution (LTE) system. Details of the technical specifications of the UMTS and E-UMTS may be understood with reference to Release 7 and Release 8 of “3rd. Generation Partnership Project; Technical Specification Group Radio Access Network”.

Referring to FIG. 1, the E-UMTS includes a User Equipment (UE), base stations (eNode B; eNB), and an Access Gateway (AG) which is located at an end of a network (E-UTRAN) and connected to an external network. The base stations may simultaneously transmit multiple data streams for a broadcast service, a multicast service and/or a unicast service.

One or more cells exist for one base station. One cell is set to one of bandwidths of 1.44, 3, 5, 10, 15 and 20 MHz to provide a downlink or uplink transport service to several user equipments. Different cells may be set to provide different bandwidths. Also, one base station controls data transmission and reception for a plurality of user equipments. The base station transmits downlink (DL) scheduling information of downlink data to the corresponding user equipment to notify the corresponding user equipment of time and frequency domains to which data will be transmitted and information related to encoding, data size, and hybrid automatic repeat and request (HARQ). Also, the base station transmits uplink (UL) scheduling information of uplink data to the corresponding user equipment to notify the corresponding user equipment of time and frequency domains that can be used by the corresponding user equipment, and information related to encoding, data size, and HARQ. An interface for transmitting user traffic or control traffic may be used between the base stations. A Core Network (CN) may include the AG and a network node or the like for user registration of the user equipment. The AG manages mobility of the user equipment on a Tracking Area (TA) basis, wherein one TA includes a plurality of cells.

Although the wireless communication technology developed based on WCDMA has been evolved into LTE, request and expectation of users and providers have continued to increase. Also, since another wireless access technology is being continuously developed, new evolution of the wireless communication technology will be required for competitiveness in the future. In this respect, reduction of cost per bit, increase of available service, use of adaptable frequency band, simple structure and open type interface, proper power consumption of the user equipment, etc. are required.

### DISCLOSURE

### Technical Problem

An object of the present invention is to provide a method of transmitting and receiving a downlink signal in a wireless communication system and an apparatus therefor.

The technical objects that can be achieved through the present invention are not limited to what has been particularly described hereinabove and other technical objects not described herein will be more clearly understood by persons skilled in the art from the following detailed description.

### Technical Solution

In an aspect of the present invention for achieving the present invention, provided herein is a method of receiving a downlink signal of a user equipment (UE) in a time division duplex (TDD) wireless communication system supporting usage change of a radio resource, including setting a first uplink (UL)-downlink (DL) configuration and a second UL-DL configuration with respect to the UE; and receiving DL control information including a specific field, wherein the specific field is defined as an independent state with respect to each of the first UL-DL configuration and the second UL-DL configuration.

The specific field may indicate a UL index with respect to the first UL-DL configuration and indicate a UL downlink assignment index (DAI) with respect to the second UL-DL configuration.

The specific field may be determined as one of the UL index and the UL DAI according to a subframe location at which the DL control information is received. The subframe location used to determine one of the UL index and the UL DAI may be indicated through higher layer signaling.

The first UL-DL configuration may be a UL hybrid automatic repeat and request (HARQ) reference configuration, the second UL-DL configuration may be a DL HARQ reference configuration, and, in the second UL-DL configuration, a UL downlink assignment index (DAI) not received together with a UL grant of the DL HARQ reference configuration may be set to a specific predefined value. The specific value may be defined as a virtual cyclic redundancy check (CRC).

The first UL-DL configuration may be a UL HARQ reference configuration and the second UL-DL configuration may be a DL HARQ reference configuration and, if the number of HARQ-acknowledgement (ACK) bits for physical uplink shared control channel (PUSCH) transmission is determined as a bundling window size for the DL HARQ reference configuration, HARQ-ACK information may be transmitted through piggyback upon receiving a physical DL shared control channel (PDSCH) or a DL semi-persistent scheduling (SPS) release signal in the bundling window.

The DL control information may be received together with a physical hybrid ARQ indicator channel (PHICH) and a state of the specific field may be defined according to the PHICH.

The DL control information may be received together with a physical hybrid ARQ indicator channel (PHICH) and a state of the specific field may be defined according to the PHICH.

The specific field may have a state defined according to a search space in which the DL control information is received.

In another aspect of the present invention for achieving the present invention, provided herein is a user equipment (UE) for receiving a downlink signal in a time division duplex (TDD) wireless communication system supporting usage change of a radio resource, including a radio frequency unit; and a processor, wherein the processor is configured to set a first uplink (UL)-downlink (DL) configuration and a second UL-DL configuration and receive DL control information including a specific field, and wherein the specific field is defined as an independent state with respect to each of the first UL-DL configuration and the second UL-DL configuration.

### Advantageous Effects

According to the present invention, a downlink signal can be transmitted and received when radio resources are dynamically changed according to system overhead in a wireless communication system.

The effects that can be achieved through the present invention are not limited to what has been particularly described hereinabove and other advantages not described herein will be more clearly understood by persons skilled in the art from the following detailed description.

### DESCRIPTION OF DRAWINGS

The accompanying drawings, which are included to provide a further understanding of the invention, illustrate embodiments of the invention and together with the description serve to explain the principle of the invention.

FIG. 1 is a diagram illustrating a network structure of an Evolved Universal Mobile Telecommunications System (E-UMTS) which is an example of a wireless communication system.

FIG. 2 is a diagram illustrating structures of a control plane and a user plane of a radio interface protocol between a user equipment and E-UTRAN based on the 3GPP radio access network standard.

FIG. 3 is a diagram illustrating physical channels used in a 3GPP LTE system and a general method for transmitting a signal using the physical channels.

FIG. 4 is a diagram illustrating a structure of a radio frame used in an LTE system.

FIG. 5 illustrates a resource grid of a DL slot.

FIG. 6 illustrates the structure of a DL subframe.

FIG. 7 illustrates the structure of a UL subframe in an LTE system.

FIG. 8 illustrates a TDD UL ACK/NACK transmission procedure in a single cell situation.

FIG. 9 illustrates ACK/NACK transmission using a DL DAI.

FIG. 10 illustrates a carrier aggregation (CA) communication system.

FIG. 11 illustrates scheduling when a plurality of carriers is aggregated

FIG. 12 illustrates an EPDCCH and a PDSCH scheduled by the EPDCCH.

FIG. 13 illustrates an example of performing CoMP.

FIG. 14 illustrates the case in which usage of a radio resource is dynamically changed in a TDD system environment.

FIG. 15 illustrates a BS and a UE which are applicable to an embodiment of the present invention.

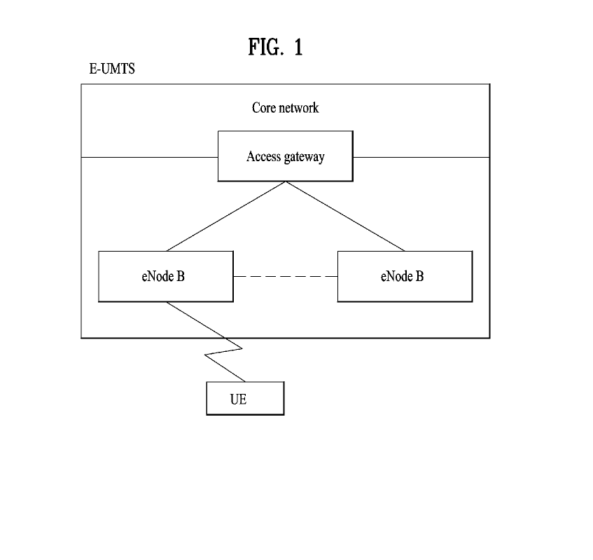

### BEST MODE

The following technology may be used for various wireless access technologies such as CDMA (code division multiple access), FDMA (frequency division multiple access), TDMA (time division multiple access), OFDMA (orthogonal frequency division multiple access), and SC-FDMA (single carrier frequency division multiple access). The CDMA may be implemented by the radio technology such as UTRA (universal terrestrial radio access) or CDMA2000. The TDMA may be implemented by the radio technology such as global system for mobile communications (GSM)/general packet radio service (GPRS)/enhanced data rates for GSM evolution (EDGE). The OFDMA may be implemented by the radio technology such as IEEE 802.11 (Wi-Fi), IEEE 802.16 (WiMAX), IEEE 802.20, and evolved. UTRA (E-UTRA). The UTRA is a part of a universal mobile telecommunications system (UMTS). A 3rd generation partnership project long term evolution (3GPP LTE) is a part of an evolved UMTS (E-UMTS) that uses E-UTRA, and adopts OFDMA in a downlink and SC-FDMA in an uplink. LTE-advanced (LTE-A) is an evolved version of the 3GPP LTE.

For clarification of the description, although the following embodiments will be described based on the 3GPP LTE/LTE-A, it is to be understood that the technical spirits of the present invention are not limited to the 3GPP LTE/LTE-A. Also, specific terminologies hereinafter used in the embodiments of the present invention are provided to assist understanding of the present invention, and various modifications may be made in the specific terminologies within the range that they do not depart from technical spirits of the present invention.

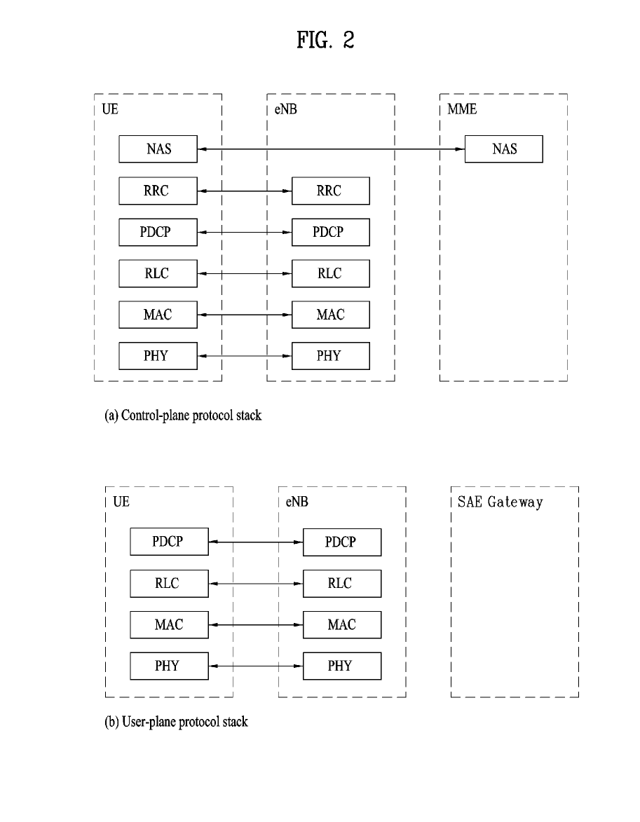

FIG. 2 is a diagram illustrating structures of a control plane and a user plane of a radio interface protocol between a user equipment and E-UTRAN based on the 3GPP radio access network standard. The control plane means a passageway where control messages are transmitted, wherein the control messages are used by the user equipment and the network to manage call. The user plane means a passageway where data generated in an application layer, for example, voice data or Internet packet data are transmitted.

A physical layer as the first layer provides an information transfer service to an upper layer using a physical channel. The physical layer is connected to a medium access control (MAC) layer via a transport channel, wherein the medium access control layer is located above the physical layer. Data are transferred between the medium access control layer and the physical layer via the transport channel. Data are transferred between one physical layer of a transmitting side and the other physical layer of a receiving side via the physical channel. The physical channel uses time and frequency as radio resources. In more detail, the physical channel is modulated in accordance with an orthogonal frequency division multiple access (OFDMA) scheme in a downlink, and is modulated in accordance with a single carrier frequency division multiple access (SC-FDMA) scheme in an uplink.

A medium access control (MAC) layer of the second layer provides a service to a radio link control (RLC) layer above the MAC layer via a logical channel. The RLC layer of the second layer supports reliable data transmission. The RLC layer may be implemented as a functional block inside the MAC layer. In order to effectively transmit data using IP packets such as IPv4 or IPv6 within a radio interface having a narrow bandwidth, a packet data convergence protocol (PDCP) layer of the second layer performs header compression to reduce the size of unnecessary control information.

A radio resource control (RRC) layer located on the lowest part of the third layer is defined in the control plane only. The RRC layer is associated with configuration, reconfiguration and release of radio bearers (‘RBs’) to be in charge of controlling the logical, transport and physical channels. In this case, the RB means a service provided by the second layer for the data transfer between the user equipment and the network. To this end, the RRC layers of the user equipment and the network exchange RRC message with each other. If the RRC layer of the user equipment is RRC connected with the RRC layer of the network, the user equipment is in an RRC connected mode. If not so, the user equipment is in an RRC idle mode. A non-access stratum (NAS) layer located above the RRC layer performs functions such as session management and mobility management.

One cell constituting a base station eNB is set to one of bandwidths of 1.4, 3.5, 5, 10, 15, and 20 MHz and provides a downlink or uplink transmission service to several user equipments. At this time, different cells may be set to provide different bandwidths.

As downlink transport channels carrying data from the network to the user equipment, there are provided a broadcast channel (BCH) carrying system information, a paging channel (PCH) carrying paging message, and a downlink shared channel (SCH) carrying user traffic or control messages. Traffic or control messages of a downlink multicast or broadcast service may be transmitted via the downlink SCH or an additional downlink multicast channel (MCH). Meanwhile, as uplink transport channels carrying data from the user equipment to the network, there are provided a random access channel (RACH) carrying an initial control message and an uplink shared channel (UL-SCH) carrying user traffic or control message. As logical channels located above the transport channels and mapped with the transport channels, there are provided a broadcast control channel (BCCH), a paging control channel (PCCH), a common control channel (CCCH), a multicast control channel (MCCH), and a multicast traffic channel (MTCH).

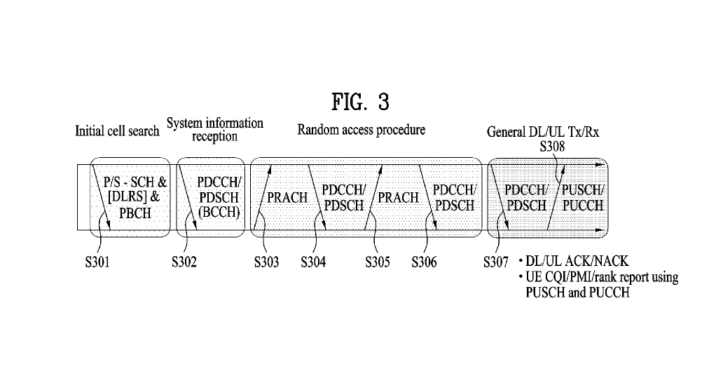

FIG. 3 is a diagram illustrating physical channels used in a 3GPP LTE system and a general method for transmitting a signal using the physical channels.

The user equipment performs initial cell search such as synchronizing with the base station when it newly enters a cell or the power is turned on at step S301. To this end, the user equipment synchronizes with the base station by receiving a primary synchronization channel (P-SCH) and a secondary synchronization channel (S-SCH) from the base station, and acquires information such as cell ID, etc. Afterwards, the user equipment may acquire broadcast information within the cell by receiving a physical broadcast channel (PBCH) from the base station. Meanwhile, the user equipment may identify a downlink channel status by receiving a downlink reference signal (DL RS) at the initial cell search step.

The user equipment which has finished the initial cell search may acquire more detailed system information by receiving a physical downlink shared channel (PDSCH) in accordance with a physical downlink control channel (PDCCH) and information carried in the PDCCH at step S302.

Afterwards, the user equipment may perform a random access procedure (RACH) such as steps S303 to S306 to complete access to the base station. To this end, the user equipment may transmit a preamble through a physical random access channel (PRACH) (S303), and may receive a response message to the preamble through the PDCCH and the PDSCH corresponding to the PDCCH (S304). In case of a contention based RACH, the user equipment may perform a contention resolution procedure such as transmission (S305) of additional physical random access channel and reception (S306) of the physical downlink control channel and the physical downlink shared channel corresponding to the physical downlink control channel.

The user equipment which has performed the aforementioned steps may receive the physical downlink control channel (PDCCH)/physical downlink shared channel (PDSCH) (S307) and transmit a physical uplink shared channel (PUSCH) and a physical uplink control channel (PUCCH) (S308), as a general procedure of transmitting uplink/downlink signals. Control information transmitted from the user equipment to the base station will be referred to as uplink control information (UCI). The UCI includes HARQ ACK/NACK (Hybrid Automatic Repeat and reQuest Acknowledgement/Negative-ACK), SR (Scheduling Request), CSI (Channel State Information), etc. In this specification, the HARQ ACK/NACK will be referred to as HARQ-ACK or ACK/NACK (A/N). The HARQ-ACK includes at least one of positive ACK (simply, referred to as ACK), negative ACK (NACK), DTX and NACK/DTX. The CSI includes CQI (Channel Quality Indicator), PMI (Precoding Matrix Indicator), RI (Rank Indication), etc. Although the UCI is generally transmitted through the PUCCH, it may be transmitted through the PUSCH if control information and traffic data should be transmitted at the same time. Also, the user equipment may non-periodically transmit the UCI through the PUSCH in accordance with request/command of the network.

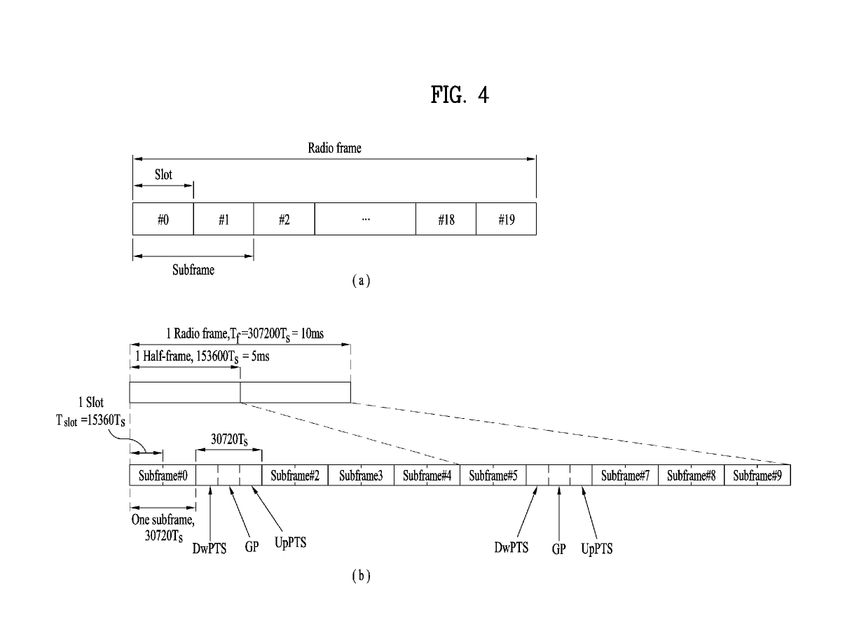

FIG. 4 is a diagram illustrating a structure of a radio frame used in an LTE system.

Referring to FIG. 4, in a cellular OFDM radio packet communication system, uplink/downlink data packet transmission is performed in a unit of subframe, wherein one subframe is defined by a given time interval that includes a plurality of OFDM symbols. The 3GPP LTE standard supports a type 1 radio frame structure applicable to frequency division duplex (FDD) and a type 2 radio frame structure applicable to time division duplex (TDD).

FIG. 4(a) is a diagram illustrating a structure of a type 1 radio frame. The downlink radio frame includes 10 subframes, each of which includes two slots in a time domain. A time required to transmit one subframe will be referred to as a transmission time interval (TTI). For example, one subframe may have a length of 1 ms, and one slot may have a length of 0.5 ms. One slot includes a plurality of OFDM symbols in a time domain and a plurality of resource blocks (RB) in a frequency domain. Since the 3GPP LTE system uses OFDM in a downlink, OFDM symbols represent one symbol interval. The OFDM symbol may be referred to as SC-FDMA symbol or symbol interval. The resource block (RB) as a resource allocation unit may include a plurality of continuous subcarriers in one slot.

The number of OFDM symbols included in one slot may be varied depending on configuration of a cyclic prefix (CP). Examples of the CP include an extended CP and a normal CP. For example, if the OFDM symbols are configured by the normal CP, the number of OFDM symbols included in one slot may be 7. If the OFDM symbols are configured by the extended CP, since the length of one OFDM symbol is increased, the number of OFDM symbols included in one slot is smaller than that of OFDM symbols in case of the normal CP. For example, in case of the extended CP, the number of OFDM symbols included in one slot may be 6. If a channel state is unstable like the case where the user equipment moves at high speed, the extended CP may be used to reduce inter-symbol interference.

If the normal CP is used, since one slot includes seven OFDM symbols, one subframe includes 14 OFDM symbols. At this time, first maximum three OFDM symbols of each subframe may be allocated to a physical downlink control channel (PDCCH), and the other OFDM symbols may be allocated to a physical downlink shared channel (PDSCH).

FIG. 4(b) is a diagram illustrating a structure of a type 2 radio frame. The type 2 radio frame includes two half frames, each of which includes four general subframes, which include two slots, and a special subframe which includes a downlink pilot time slot (DwPTS), a guard period (GP), and an uplink pilot time slot (UpPTS).

In the special subframe, the DwPTS is used for initial cell search, synchronization or channel estimation at the user equipment. The UpPTS is used for channel estimation at the base station and uplink transmission synchronization of the user equipment. In other words, the DwPTS is used for downlink transmission, whereas the UpPTS is used for uplink transmission. Especially, the UpPTS is used for PRACH preamble or SRS transmission. Also, the guard period is to remove interference occurring in the uplink due to multipath delay of downlink signals between the uplink and the downlink.

Configuration of the special subframe is defined in the current 3GPP standard document as illustrated in Table 1 below. Table 1 illustrates the DwPTS and the UpPTS in case of Tₛ=1/(15000×2048), and the other region is configured for the guard period.

TABLE 1

| | Normal cyclic prefix in downlink | | | Extended cyclic prefix in downlink | | |
|---|---|---|---|---|---|---|
| | | UpPTS | | | UpPTS | |
| Special | | Normal | Extended | | Normal | Extended |
| subframe | | cyclic prefix | cyclic prefix | | cyclic prefix | cyclic prefix |
| configuration | DwPTS | in uplink | in uplink | DwPTS | in uplink | in uplink |
| 0 | 6592 · T_{S} | 2192 · T_{S} | 2560 · T_{S} | 7680 · T_{S} | 2192 · T_{S} | 2560 · T_{S} |
| 1 | 19760 · T_{S} | | | 20480 · T_{S} | | |
| 2 | 21952 · T_{S} | | | 23040 · T_{S} | | |
| 3 | 24144 · T_{S} | | | 25600 · T_{S} | | |
| 4 | 26336 · T_{S} | | | 7680 · T_{S} | 4384 · T_{S} | 5120 · T_{S} |
| 5 | 6592 · T_{S} | 4384 · T_{S} | 5120 · T_{S} | 20480 · T_{S} | | |
| 6 | 19760 · T_{S} | | | 23040 · T_{S} | | |
| 7 | 21952 · T_{S} | | | 12800 · T_{S} | | |
| 8 | 24144 · T_{S} | | | — | — | — |
| 9 | 13168 · T_{S} | | | — | — | — |

In the meantime, the structure of the type 2 radio frame, that is, uplink/downlink configuration (UL/DL configuration) in the TDD system is as illustrated in Table 2 below.

TABLE 2

| | Downlink-to- | | | | | | | | | | |
|---|---|---|---|---|---|---|---|---|---|---|---|
| DL-UL | Uplink | | | | | | | | | | |
| configu- | Switch-point | Subframe number | | | | | | | | | |
| ration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In the above Table 2, D means the downlink subframe, U means the uplink subframe, and S means the special subframe. Also, Table 2 also illustrates a downlink-uplink switching period in the uplink/downlink subframe configuration of each system.

The structure of the aforementioned radio frame is only exemplary, and various modifications may be made in the number of subframes included in the radio frame, the number of slots included in the subframe, or the number of symbols included in the slot.

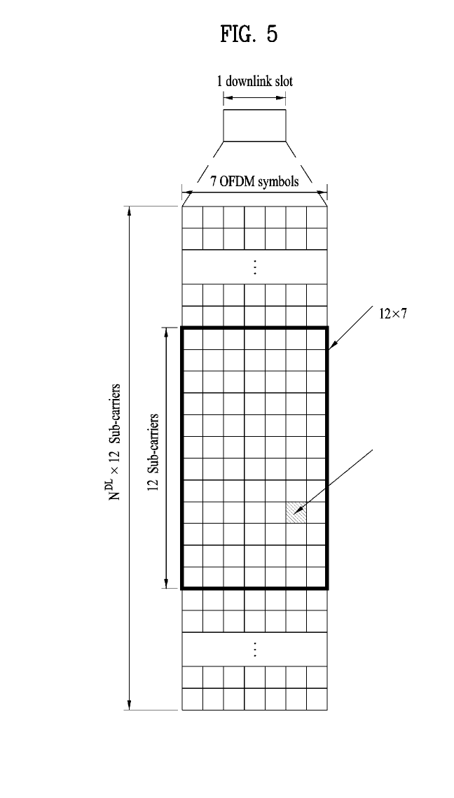

FIG. 5 is a diagram illustrating a resource grid of a downlink slot.

Referring to FIG. 5, the downlink slot includes a plurality of N_{symb}^{DL} OFDM symbols in a time domain and a plurality of N_{RB}^{DL} resource blocks in a frequency domain. Since each resource block includes N_{sc}^{RB} subcarriers, the downlink slot includes N_{RB}^{DL}×N_{sc}^{RB} subcarriers in the frequency domain. Although FIG. 5 illustrates that the downlink slot includes seven OFDM symbols and the resource block includes twelve subcarriers, it is to be understood that the downlink slot and the resource block are not limited to the example of FIG. 5. For example, the number of OFDM symbols included in the downlink slot may be varied depending on the length of the CP.

Each element on the resource grid will be referred to as a resource element (RE). One resource element is indicated by one OFDM symbol index and one subcarrier index. One RB includes N_{symb}^{DL}×N_{sc}^{RB} number of resource elements. The number N_{RB}^{DL} of resource blocks included in the downlink slot depends on a downlink transmission bandwidth configured in the cell.

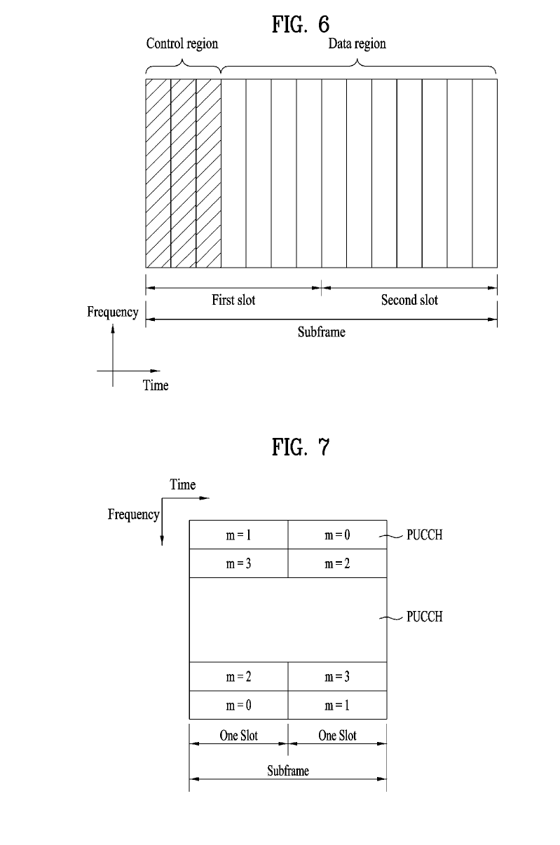

FIG. 6 illustrates the structure of a DL subframe.

Referring to FIG. 6, up to three (or four) OFDM symbols located at the start of the first slot of a DL subframe are used as a control region to which control channels are allocated and the other OFDM symbols of the DL subframe are used as a data region to which a PDSCH is allocated. DL control channels defined for an LTE system include a physical control format indicator channel (PCFICH), a physical downlink control channel (PDCCH), and a physical hybrid ARQ indicator channel (PHICH). The PCFICH is transmitted in the first OFDM symbol of a subframe, carrying information about the number of OFDM symbols used for transmission of control channels in the subframe. The PHICH delivers a HARQ ACK/NACK signal as a response to UL transmission.

An eNB transmits information related to resource assignment of a PCH and a DL-SCH which are transport channels, a UL scheduling grant, HARQ information, a downlink assignment index (DAI), etc. to a UE or a UE group over the PDCCH. The DAI may indicate an order value or a counter value of the PDCCH. For convenience, a value indicated by a DAI field of a DL grant PDCCH is referred to as a DL DAI and a value indicated by a DAI field of a UL grant is referred to as a UL DAI.

Control information carried on the PDCCH is called downlink control information (DCI). The DCI transports resource allocation information and other control information for a UE or a UE group. For example, the DCI includes DL/UL scheduling information, UL transmit (Tx) power control commands, etc.

The PDCCH delivers information about a transport format and resource allocation for a downlink shared channel (DL-SCH), information about a transport format and resource allocation for an uplink shared channel (UL-SCH), paging information of a paging channel (PCH), system information on the DL-SCH, information about resource allocation for a higher-layer control message such as a random access response transmitted on the PDSCH, a set of transmit power control commands for individual UEs of a UE group, Tx power control commands, voice over Internet protocol (VoIP) activation indication information, etc. A plurality of PDCCHs may be transmitted in the control region. A UE may monitor a plurality of PDCCHs. A PDCCH is transmitted on an aggregate of one or more consecutive control channel elements (CCEs). A CCE is a logical allocation unit used to provide a PDCCH at a coding rate based on the state of a radio channel A CCE corresponds to a plurality of resource element groups (REGs). The format of a PDCCH and the number of available bits for the PDCCH are determined according to the number of CCEs. An eNB determines a PDCCH format according to DCI transmitted to a UE and attaches a cyclic redundancy check (CRC) to control information. The CRC is masked with an identifier (ID) (e.g. a radio network temporary identifier (RNTI)) according to the owner or use of the PDCCH. If the PDCCH is destined for a specific UE, the CRC may be masked with a cell-RNTI (C-RNTI) of the UE. If the PDCCH carries a paging message, the CRC may be masked with a paging ID (P-RNTI). If the PDCCH carries system information (particularly, a system information block (SIB)), the CRC may be masked with a system information RNTI (SI-RNTI). If the PDCCH is designated as a random access response, the CRC may be masked with a random access-RNTI (RA-RNTI).

A DCI format will now be described in detail.

DCI formats 0, 1, 1A, 1B, 1C, 1D, 2, 2A, 2B, 2C, 3, 3A and 4 are defined in LTE-A (Release 10). DCI formats 0, 1A, 3, and 3A are defined to have the same message size to reduce the number of blind decoding operations, which will be described later. The DCI formats may be divided into i) DCI formats 0 and 4 used for UL grant, ii) DCI formats 1, 1A, 1B, 1C, 1D, 2, 2A, 2B, and 2C used for DL scheduling allocation, and iii) DCI formats 3 and 3A used to carry a power control command.

DCI format 0 used for UL grant may include a carrier indicator necessary for carrier aggregation, which will be described later, an offset (flag for format 0/format 1A differentiation) used to differentiate DCI formats 0 and 1A from each other, a frequency hopping flag that indicates whether frequency hopping is used for UL PUSCH transmission, information about resource block assignment, used for a UE to transmit a PUSCH, a modulation and coding scheme, a new data indicator used to empty a buffer for initial transmission in relation to a HARQ process, a transmit power control (TPC) command for a scheduled PUSCH, information about a cyclic shift for a demodulation reference signal (DMRS) and OCC index, and a UL index and channel quality indicator request (CSI request) necessary for a TDD operation, etc. DCI format 0 does not include a redundancy version, unlike DCI formats related to DL scheduling allocation since DCI format 0 uses synchronous HARQ. The carrier indicator is not included in DCI formats when cross-carrier scheduling is not used.

DCI format 4, which is newly added to DCI formats in LTE-A Release 10, supports application of spatial multiplexing to UL transmission in LTE-A. DCI format 4 has a larger message size than DCI format 0 because it further includes information for spatial multiplexing. DCI format 4 includes additional control information in addition to control information included in DCI format 0. That is, DCI format 4 includes information on a modulation and coding scheme for the second transmission block, precoding information for multi-antenna transmission, and sounding reference signal (SRS) request information. DCI format 4 does not include an offset for differentiation between formats 0 and 1A because it has a larger size than DC1 format 0.

DCI formats 1, 1A, 1B, 1C, 1D, 2, 2A, 2B and 2C for DL scheduling allocation may be broadly divided into DCI formats 1, 1A, 1B, 1C and 1D, which do not support spatial multiplexing, and DCI formats 2, 2A, 2B and 2C, which support spatial multiplexing.

DCI format 1C supports only frequency contiguous allocation as compact frequency allocation and does not include the carrier indicator and redundancy version, compared to the other formats.

DCI format 1A is for DL scheduling and a random access procedure. DCI format 1A may include a carrier offset, an indicator that indicates whether DL distributed transmission is used, PDSCH resource allocation information, a modulation and coding scheme, a redundancy version, a HARQ processor number for indicating a processor used for soft combining, a new data indicator used to empty a buffer for initial transmission in relation to a HARQ process, a TPC command for a PUCCH, a UL index necessary for a TDD operation, etc.

DCI format 1 includes control information similar to that of DCI format 1A. DCI format 1 supports non-contiguous resource allocation, while DCI format 1A is related to contiguous resource allocation. Accordingly, DCI format 1 further includes a resource allocation header, and thus slightly increases control signaling overhead as a trade-off for increase in flexibility of resource allocation.

Both DCI formats 1B and 1D further include precoding information, compared to DCI format 1. DCI format 1B includes PMI acknowledgement and DCI format 1D includes DL power offset information. Most control information included in DCI formats 1B and 1D corresponds to that of DCI format 1A.

DCI formats 2, 2A, 2B, and 2C basically include most control information included in DCI format 1A and further include information for spatial multiplexing. The information for spatial multiplexing includes a modulation and coding scheme for the second transmission block, a new data indicator, and a redundancy version.

DCI format 2 supports closed loop spatial multiplexing, and DCI format 2A supports open loop spatial multiplexing. Both DCI formats 2 and 2A include precoding information. DCI format 2B supports dual layer spatial multiplexing combined with beamforming and further includes cyclic shift information for a DMRS. DCI format 2C, which may be regarded as an extended version of DCI format 2B, supports spatial multiplexing for up to 8 layers.

DCI formats 3 and 3A may be used to complement the TPC information included in the aforementioned DCI formats for UL grant and DL scheduling allocation, namely, to support semi-persistent scheduling. A 1-bit command is used per UE in the case of DCI format 3, while a 2-bit command is used per UE in the case of DCI format 3A.

One of the DCI formats described above is transmitted through a PDCCH, and a plurality of PDCCHs may be transmitted in a control region. A UE may monitor the plurality of PDCCHs.

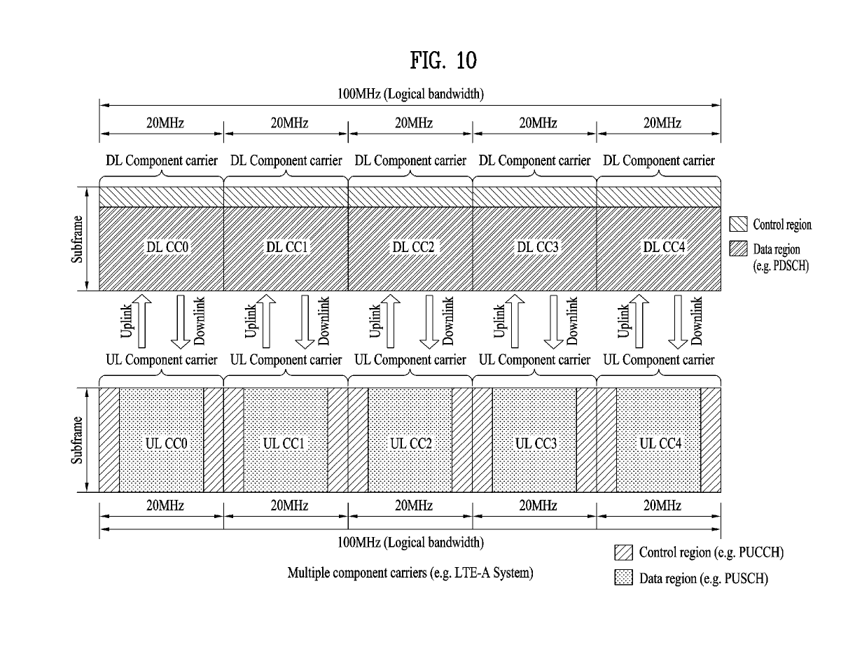

FIG. 10 illustrates the structure of a UL subframe in an LTE system.

Referring to FIG. 10, a UL subframe includes a plurality of (e.g. 2) slots. A slot may include a different number of SC-FDMA symbols according to CP length. The UL subframe is divided into a control region and a data region in the frequency domain. The data region includes a PUSCH to transmit a data signal such as voice and the control region includes a PUCCH to transmit UCI. The PUCCH occupies a pair of RBs at both ends of the data region in the frequency domain and the RB pair frequency-hops over a slot boundary.

The PUCCH may deliver the following control information.
SR: SR is information requesting UL-SCH resources and is transmitted using on-off keying (OOK).
HARQ ACK/NACK: HARQ ACK/NACK is a response signal to a DL data packet received on a PDSCH, indicating whether the DL data packet has been successfully received. 1-bit ACK/NACK is transmitted as a response to a single DL codeword and 2-bit ACK/NACK is transmitted as a response to two DL codewords.
CSI: CSI is feedback information regarding a DL channel. CSI includes a CQI and multiple input multiple output (MIMO)-related feedback information includes an RI, a PMI, a preceding type indicator (PTI), etc. The CSI occupies 20 bits per subframe.

The amount of UCI that the UE may transmit in a subframe depends on the number of SC-FDMA symbols available for transmission of control information. The remaining SC-FDMA symbols except for SC-FDMA symbols allocated to RSs in a subframe are available for transmission of control information. If the subframe carries an SRS, the last SC-FDMA symbol of the subframe is also excluded in transmitting the control information. The RSs are used for coherent detection of the PUCCH.

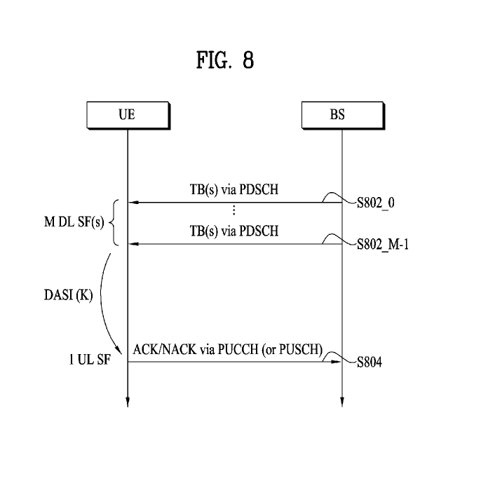

FIG. 8 illustrates a TDD UL ACK/NACK transmission procedure in a single cell situation.

Referring to FIG. 8, a UE may receive one or more PDSCH signals in M DL subframes (S802_0 to S802_M−1). Each PDSCH signal is used to transmit one or more (e.g. 2) transport blocks (TBs) (or codewords (CWs)) according to transmission mode. A PDCCH signal requiring an ACK/NACK response, for example, a PDCCH signal indicating release of semi-persistent scheduling (SPS) (simply, an SPS release PDCCH signal) may also be received in steps S802_0 to S802_M−1, which is not shown. When a PDSCH signal and/or an SPS release PDCCH signal are present in the M DL subframes, the UE transmits ACK/NACK in one UL subframe corresponding to the M DL subframes through a procedure for transmitting ACK/NACK (e.g. ACK/NACK (payload) generation, ACK/NACK resource allocation, etc.) (S804). ACK/NACK includes ACK information for the PDSCH signal and/or SPS release PDCCH received in step S802_0 to S802_M−1. While ACK/NACK is transmitted through a PUCCH basically, ACK/NACK is transmitted through a PUSCH when the PUSCH is transmitted at ACK/NACK transmission timing. Various PUCCH formats shown in Table 2 may be used for ACK/NACK transmission. To reduce the number of ACK/NACK bits transmitted through a PUCCH format, various methods such as ACK/NACK bundling and ACK/NACK channel selection may be used.

As described above, in TDD, ACK/NACK for data received in the M DL subframes is transmitted through one UL subframe (i.e., M DL SF(s): 1 UL SF) and the relationship therebetween is determined by a downlink association set index (DASD.

Table 3 shows DASI (K: {k0, k1, . . . , k−1}) defined in LTE(−A). Table 3 shows intervals between a UL subframe transmitting ACK/NACK and a DL subframe associated with the UL subframe from the perspective of the UL subframe. Specifically, when a PDCCH that indicates PDSCH transmission and/or SPS release is present in subframe n−k (where kεK), the UE transmits ACK/NACK for the PDCCH in subframe n.

TABLE 3

| UL-DL | | | | | | | | | | |
|---|---|---|---|---|---|---|---|---|---|---|
| Con- | | | | | | | | | | |
| figura- | Subframe n | | | | | | | | | |
| tion | 0 | 1 | 2 | 3 | 4 | 5 | 6 | 7 | 8 | 9 |
| 0 | — | — | 6 | — | 4 | — | — | 6 | — | 4 |
| 1 | — | — | 7, 6 | 4 | — | — | — | 7, 6 | 4 | — |
| 2 | — | — | 8, 7, 4, | — | — | — | — | 8, 7, 4, | — | — |
| | | | 6 | | | | | 6 | | |
| 3 | — | — | 7, 6, 11 | 6, 5 | 5, 4 | — | — | — | — | — |
| 4 | — | — | 12, 8, 7, | 6, 5, 4, | — | — | — | — | — | — |
| | | | 11 | 7 | | | | | | |
| 5 | — | — | 13, 12, | — | — | — | — | — | — | — |
| | | | 9, 8, 7, | | | | | | | |
| | | | 5, 4, | | | | | | | |
| | | | 11, 6 | | | | | | | |
| 6 | — | — | 7 | 7 | 5 | — | — | 7 | 7 | — |

When a plurality of PDSCHs is transmitted to one UE in a plurality of DL subframes, an eNB transmits a plurality of PDCCHs, one PDCCH for each PDSCH. In this case, the UE transmits ACK/NACK for the PDSCHs in one UL subframe over a PUCCH or a PUSCH. A scheme for transmitting ACK/NACK for a plurality of PDSCHs when the UE operates in a TDD mode in legacy LTE is broadly divided into two schemes as follows.

1) ACK/NACK bundling: ACK/NACK bits for a plurality of data units (e.g. a PDSCH, an SPS release PDCCH, etc.) are combined by logic-AND operation. For example, a receiving end (e.g. UE) transmits an ACK signal upon successfully decoding all data units and transmits a NACK signal or no signal upon failing to decode (or detect) any one of the data units.

2) Channel selection transmission: Upon receiving a plurality of PDSCHs, the UE occupies a plurality of PUCCH resources for ACK/NACK transmission. ACK/NACK responses to a plurality of data units are identified by a combination of a PUCCH resource used for actual ACK/NACK transmission and transmitted ACK/NACK content (e.g. a bit value).

When the UE transmits ACK/NACK signals to the eNB in TDD, the following problems may arise.
When the UE has missed some of PDCCH(s) transmitted by the eNB in multiple subframes, the UE cannot be aware that PDSCHs corresponding to the missed PDCCHs have been transmitted thereto and, thus, errors may occur during ACK/NACK generation.

To resolve the errors, a DAI is included in a PDCCH in a TDD system. The DAI indicates an accumulative value (i.e., a counted value) of PDCCH(s) corresponding to PDSCH(s) and PDCCH(s) indicating DL SPS release in up to a current subframe within DL subframe(s) n−k (kεK). For example, when three DL subframes correspond to one UL subframe, indexes are sequentially assigned (i.e., sequentially counted) to PDSCHs transmitted in the three DL subframes and carried on a PDCCH for scheduling the PDSCHs. The UE can be aware that previous PDCCHs have been successfully received through DAI information included in the PDCCH. For convenience, a DAI included in a PDSCH-scheduling PDCCH and an SPS release PDCCH is referred to as a DL DAI, a DAI-c (counter), or simply a DAI.

Table 4 shows a value V_{DAI}^{DL} indicated by a DL DAI field.

TABLE 4

| DAI | | Number of subframes with PDSCH transmission |
|---|---|---|
| MSB, LSB | V_{DAI}^{DL} | and with PDCCH indicating DL SPS release |
| 0, 0 | 1 | 1 or 5 or 9 |
| 0, 1 | 2 | 2 or 6 |
| 1, 0 | 3 | 3 or 7 |
| 1, 1 | 4 | 0 or 4 or 8 |

MSB: Most significant bit.
LSB: Least significant bit.

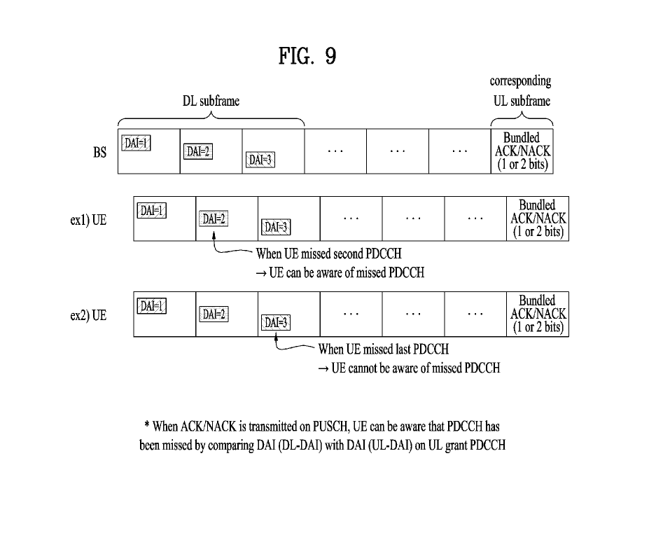

FIG. 9 illustrates ACK/NACK transmission using a DL DAI. This example is based on a TDD system with 3 DL subframes: 1 UL subframe. For convenience, it is assumed that a UE transmits ACK/NACK using a PUSCH resource. In legacy LTE, when ACK/NACK is transmitted through a PUSCH, 1-bit or 2-bit bundled ACK/NACK is transmitted.

Referring to FIG. 9, when the UE misses the second PDCCH as in the first example, the UE can be aware that the second PDCCH has been missed because a DL DAI value of the third PDCCH is different from the number of PDCCHs detected until then. In this case, the UE can process an ACK/NACK response to the second PDCCH as NACK (or NACK/DTX). On the other hand, when the UE misses the last PDCCH as in the second example, the UE cannot be aware that the last PDCCH has been missed because a DAI value of the last detected PDCCH corresponds to the number of PDCCHs detected until then (i.e. DTX). Accordingly, the UE recognizes that only two PDCCHs have been scheduled during a DL subframe period. In this case, an error is generated during an ACK/NACK feedback process because the UE bundles only ACK/NACK corresponding to the first two PDCCHs. To solve this problem, a PUSCH-scheduling PDCCH (i.e., a UL grant PDCCH) includes a DAI field (for convenience, a UL DAI field). The UL DAI field is a 2-bit field and represents information about the number of scheduled PDCCHs.

Specifically, the UE assumes that at least one DL allocation is lost (i.e., DTX is generated) when V_{DAI}^{UL}≠(U_{DAI}+N_{SPS}−1) mod 4+1 and generates NACK for all codewords according to bundling. Here, U_{DAI} denotes the total number of DL grant PDCCHs and SPS release PDCCHs detected in a subframe n−k (kεK)) (refer to Table 3) and N_{SPS} denotes the number of SPS PDSCHs and corresponds to 0 or 1.

Table 5 shows a value (V_{DAI}^{DL}) indicated by the UL DAI field.

TABLE 5

| DAI | | Number of subframes with PDSCH transmission |
|---|---|---|
| MSB, LSB | V_{DAI}^{UL} | and with PDCCH indicating DL SPS release |
| 0, 0 | 1 | 1 or 5 or 9 |
| 0, 1 | 2 | 2 or 6 |
| 1, 0 | 3 | 3 or 7 |
| 1, 1 | 4 | 0 or 4 or 8 |

MSB: Most significant bit.
LSB: Least significant bit.

FIG. 10 illustrates a carrier aggregation (CA) communication system.

Referring to FIG. 10, a plurality of UL/DL component carriers CCs can be aggregated to support a wider UL/DL bandwidth. The term “CC” may be replaced with other equivalent terms (e.g., carrier, cell, etc.). The CCs may be contiguous or non-contiguous in the frequency domain. Bandwidths of the CCs can be independently determined Asymmetrical CA in which the number of UL CCs is different from the number of DL CCs can be implemented. Meanwhile, control information may be configured to be transmitted/received only through a specific CC. This specific CC may be referred to as a primary CC (PCC) (or anchor CC) and other CCs may be referred to as secondary CCs (SCCs).

When cross-carrier scheduling (or cross-CC scheduling) is applied, a PDCCH for DL allocation may be transmitted on DL CC#0 and a PDSCH corresponding to the PDCCH may be transmitted on DL CC#2. A carrier indicator field (CIF) may be introduced for cross-CC scheduling. Whether the CIF is present in the PDCCH may be indicated semi-statically and UE-specifically (or UE group-specifically) through higher layer signaling (e.g., RRC signaling). The baseline of PDCCH transmission is summarized as follows.
CIF disabled: a PDCCH on a DL CC is used to allocate a PDSCH resource on the same DL CC or a PUSCH resource on a single linked UL CC.
No CIF
Same as an LTE PDCCH structure (same coding and same control channel element (CCE)-based resource mapping) and a DCI format
CIF enabled: a PDCCH on a DL CC can be used to allocate a PDSCH/PUSCH resource on a specific DL/UL CC from among a plurality of aggregated DL/UL CCs using CIF.
Extended LTE DCI format with a CIF
   CIF (if configured) is a fixed x-bit field (e.g., x=3)
   CIF (if configured) location is fixed regardless of DCI format size
Reuse of the LTE PDCCH structure (same coding and same CCE-based resource mapping)

When the CIF is present, a BS may allocate a PDCCH monitoring DL CC to reduce blind decoding complexity of the UE. The PDCCH monitoring DL CC set includes one or more DL CCs as parts of aggregated DL CCs and the UE detects/decodes a PDCCH only on the corresponding DL CCs. That is, when the BS schedules a PDSCH/PUSCH for the UE, a PDCCH is transmitted only through the PDCCH monitoring DL CC set. The PDCCH monitoring DL CC set may be configured in a UE-specific, UE-group-specific or cell-specific manner. The term “PDCCH monitoring DL CC” may be replaced with terms such as “monitoring carrier” and “monitoring cell”. The term “CC” aggregated for the UE may be replaced with terms such as “serving CC”, “serving carrier”, and “serving cell”.

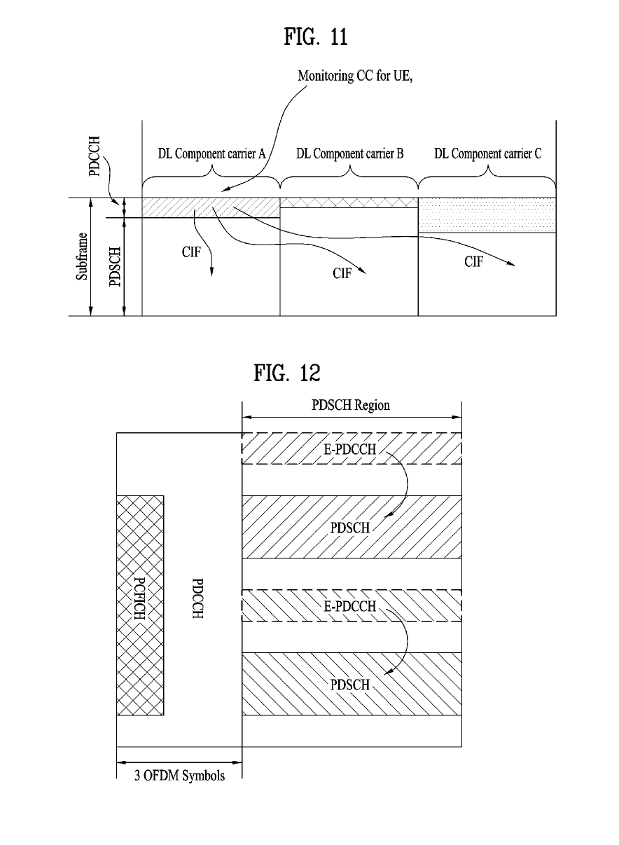

FIG. 11 illustrates scheduling when a plurality of carriers is aggregated. It is assumed that 3 DL CCs are aggregated and DL CC A is configured as a PDCCH monitoring DL CC. DL CC A, DL CC B and DL CC C may be called serving CCs, serving carriers, serving cells, etc. In case of CIF disabled, each DL CC may transmit only a PDCCH that schedules a PDSCH corresponding to the DL CC without the CIF according to LTE PDCCH configuration. When the CIF is enabled by UE-specific (or UE-group-specific or cell-specific) signaling, DL CC A (monitoring DL CC) may transmit not only a PDCCH that schedules the PDSCH corresponding to the DL CC A but also PDCCHs that schedule PDSCHs of other DL CCs using the CIF. In this case, a PDCCH is not transmitted on DL CC B/C which is not configured as a PDCCH monitoring DL CC. Therefore, DL CC A (monitoring CC) needs to include all of a PDCCH search space (SS) related to DL CC A, a PDCCH search space related to DL CC B, and a PDCCH SS related to DL CC C. In this specification, it is assumed that a PDCCH SS is defined on a carrier basis.

As described above, introduction of a CIF is considered in a PDCCH for cross-CC scheduling. Presence/absence of the CIF (i.e., support of a cross-CC scheduling mode or a non-cross-CC scheduling mode) and mode switching may be semi-statically/UE-specifically configured through RRC signaling and the UE that has completed the corresponding RRC signaling procedure may recognize whether the CIF is used in a PDCCH that is to be scheduled therefor.

FIG. 12 illustrates an EPDCCH and a PDSCH scheduled by the EPDCCH.

Referring to FIG. 12, an EPDCCH may use a PDSCH region by defining a part of the PDSCH region in which data is generally transmitted and a UE needs to perform blind decoding to detect presence or absence of an EPDCCH thereof. The EPDCCH performs the same scheduling operation (i.e., control of a PDSCH or a PUSCH) as a legacy PDCCH. However, if the number of UEs accessing a node such as a remote radio head (RRH) increases, more EPDCCHs are allocated in the PDSCH region and, thus, the number of blind decoding procedures that the UE should perform increases, thereby increasing complexity.

Hereinafter, cooperative multipoint transmission/reception (CoMP) will be described.

A system introduced after LTE-A has attempted to adopt a scheme for raising system performance by enabling cooperation among a plurality of cells. Such a scheme is called CoMP. CoMP refers to a scheme for two or more eNBs, access points, or cells to cooperatively communicate with a specific UE for smooth communication between the UE and the eNBs, access points, or cells. In the present invention, eNB, access point, and cell may have the same meaning.

In general, in a multi-cell environment in which a frequency reuse factor is 1, the performance of the UE located at the cell edge and average sector throughput may be reduced due to inter-cell interference (ICI). In order to reduce ICI, in a legacy LTE system, a method of enabling the UE located at the cell edge to have appropriate throughput and performance using a simple passive scheme such as fractional frequency reuse (FFR) through UE-specific power control in an environment restricted by interference has been applied. However, rather than decreasing use of frequency resources per cell, it is desirable to reduce ICI or reuse ICI as a signal desired by the UE. In order to accomplish the above object, a CoMP transmission scheme may be applied.

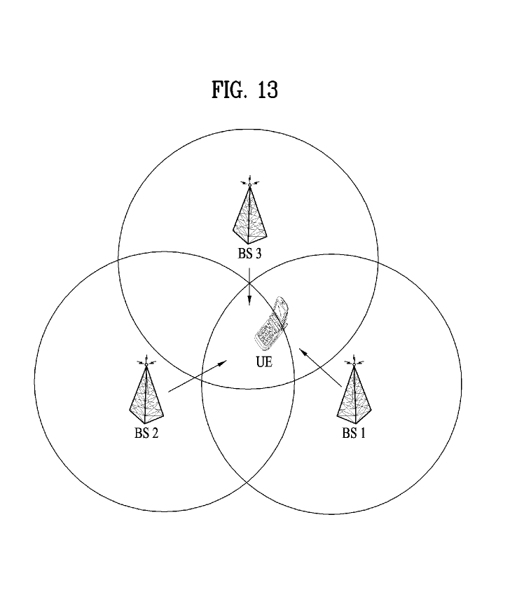

FIG. 13 illustrates an example of performing CoMP. Referring to FIG. 13, a radio communication system includes a plurality of BSs BS1, BS2, and BS3 that perform CoMP and a UE. The BSs BS1, BS2, and BS3 that perform CoMP may efficiently transmit data to the UE through cooperation. CoMP may be broadly divided into two schemes according to whether data is transmitted from each BS that performs CoMP:
CoMP joint processing (CoMP-JP)
CoMP cooperative scheduling/beamforming (CoMP-CS/CB or CoMP cooperative scheduling (CoMP-CS))

In the case of CoMP-JP, data is simultaneously transmitted from BSs performing CoMP to one UE and the UE combines signals received from the BSs to improve reception performance. That is, the CoMP-JP scheme may use data in points (BSs) of a CoMP cooperative unit. The CoMP cooperative unit means a set of BSs used for a CoMP scheme. The JP scheme may be classified into a joint transmission scheme and a dynamic cell selection scheme.

The joint transmission scheme refers to a scheme for transmitting a PDSCH from a plurality of transmission points (a part or all of the CoMP cooperative unit). That is, data transmitted to a single UE may be simultaneously transmitted from a plurality of transmission points. According to the joint transmission scheme, it is possible to coherently or non-coherently improve the quality of received signals and to actively eliminate interference with another UE.

The dynamic cell selection scheme refers to a scheme for transmitting a PDSCH from one point (of the CoMP cooperative unit) at a time. That is, data transmitted to a single UE at a specific time is transmitted from one point and the other transmission points in the cooperative unit at that time do not transmit data to the UE. A transmission point for transmitting the data to the UE may be dynamically selected.

Meanwhile, in the case of CoMP-CS, data transmitted to one UE is transmitted from one BS at an arbitrary timing and scheduling or beamforming is performed to minimize interference caused by another BS. That is, according to the CoMP-CS/CB scheme, CoMP units may cooperatively perform beamforming of data transmission to a single UE. Although data is transmitted only by a serving cell, user scheduling/beamforming may be determined by coordination among cells of a corresponding CoMP unit.

In UL, coordinated multi-point reception refers to reception of a signal transmitted by coordination among a plurality of geographically separated points. The CoMP scheme applicable to UL may be classified into joint reception (JR) and coordinated scheduling/beamforming (CS/CB).

The JR scheme indicates that a plurality of reception points receives a signal transmitted through a PUSCH. While the CS/CB scheme indicates that only one point receives the signal transmitted through the PUSCH, user scheduling/beamforming is determined by coordination among the cells of the CoMP cooperative unit.

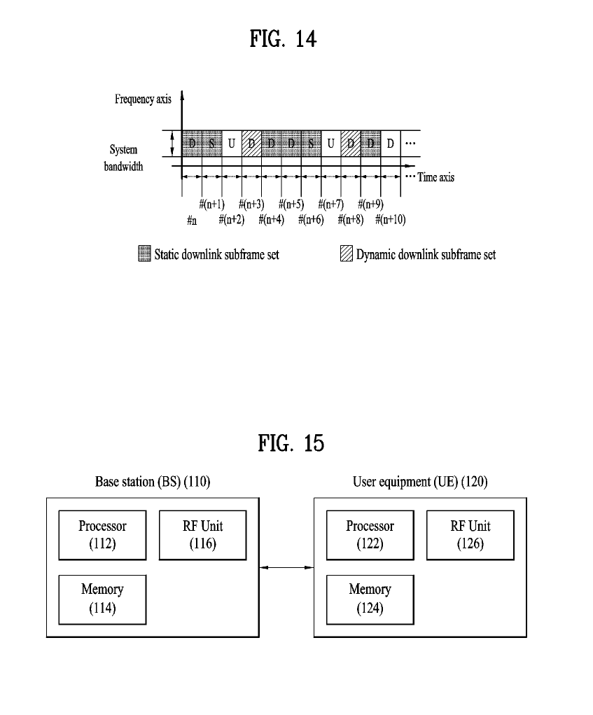

FIG. 14 illustrates the case in which a specific cell uses a part of legacy UL resources (i.e., UL subframes) for DL communication according to increase in DL overhead of a system in a TDD system environment. In FIG. 14, it is assumed that UL-DL configuration based on an SIB is UL-DL configuration #1 (i.e., DSUUDDSUUD) and usage of existing UL subframe #(n+3) and subframe #(n+8) is changed to be used for DL communication through a predefined signal (e.g., a physical/higher layer signal or a system information signal).

Based on the above description, in the present invention, a method is described of efficiently interpreting/using a “UL index field” of a specific DCI format (e.g., DCI format 0 and/or DCI format 4) and/or a “UL DAI”, when a cell dynamically changes usage of a radio resource according to a system overhead state.

For convenience of description, the present invention will be described hereinbelow based on a 3GPP LTE system. However, the range of a system, to which the present invention is applied, may be extended to systems other than the 3GPP LTE system. An embodiment of the present invention may also be extended even when usage of a resource on a specific cell or CC in an environment in which CA is applied is dynamically changed according to a system overhead state. In addition, embodiments of the present invention may also be extended even upon dynamically changing usage of a radio resource in a TDD system or an FDD system.

In a legacy LTE TDD system, a specific field (i.e., 2 bits) of DCI format 0 and/or DCI format 4 indicates whether the field is interpreted as UL index information or UL DAI information according to whether SIB1 information based UL-DL configuration (i.e., a PCell) related to a cell (or a CC) in which a corresponding DCI format is transmitted or RadioResourceConfigCommonSCell IE information based UL-DL configuration (i.e., an SCell) is set to UL-DL configuration #0. That is, for UL-DL configuration #0, the field is interpreted as the UL index information and, for the other configurations, the field is interpreted as the UL DAI information.

In addition, when a specific cell dynamically changes usage of a radio resource according to a system overhead state of a system, in terms of a specific UE (eIMTA UE) that performs communication with the cell, SIB1 information based UL-DL configuration or RadioResourceConfigCommonSCell IE information based UL-DL configuration, DL HARQ reference configuration related UL-DL configuration, UL HARQ reference configuration related UL-DL configuration, and currently (re)configured UL-DL configuration are present.

Under the above situation, the UE (eIMTA UE) does not accurately determine on which UL-DL configuration is based upon interpreting the specific field (i.e., 2 bits) of DCI format 0/4 as the UL index information or the UL DAI information. Here, a UL DAI indicates “the total number of subframes (SFs) related to PDSCHs transmitted to the UE (PDSCH transmission related SFs) and PDCCH/EPDCCH transmission related SFs for indicating DL SPS release information in a predefined bundling window” in terms of a BS. The UE may verify (re-verify) whether the UE fails to receive a PDCCH/EPDCCH in the predefined bundling window by receiving the UL DAI information. In addition, the UE may verify “whether single UL DCI information (i.e., DCI format 0/4) schedules one PUSCH or a plurality of (i.e., two) PUSCHs” by receiving a UL index of a specific value (e.g., 11).

For example, when a specific cell dynamically changes usage of a radio resource according to a system overhead state, if i) UL HARQ reference configuration and DL HARQ reference configuration of a specific UE (eIMTA UE) that performs communication with the cell are respectively set to UL-DL configuration #0 and UL-DL configuration #2 (which is one of UL-DL configurations #{2, 4, 5}) or ii) UL HARQ reference configuration and (re)configured UL-DL configuration of the UE are respectively set to UL-DL configuration #0 and UL-DL configuration #2, then the UL index information and/or the UL DAI information of DCI format 0/4 are simultaneously needed for efficient UL/DL communication of the UE. Hereinafter, embodiments of the present invention to solve the above problem will be described.

### 1. First Embodiment

According to a first embodiment of the present invention, in a situation in which UL HARQ reference configuration (or SIB1 information based UL-DL configuration) is set to UL-DL configuration #0, if DL HARQ reference configuration is set to one of UL-DL configurations #{2, 4, 5} (i.e., UL and DL HARQ reference configurations are set to different UL-DL configurations), a field of a predefined bit size (e.g., 2 bits) may be added to DCI format 0/4.

Here, the added field may be configured to be used to transmit UL DAI information (or UL index information) and then DCI format 0/4 may include both a UL index information transmission related field and a UL DAI information transmission related field. Further, i) information about for which usage the added field is used and/or ii) information about the bit size of the added field may be configured such that a BS informs a UE of the information through a predefined signal (e.g., a physical layer signal or a higher layer signal) or may be configured to be implicitly recognized by a predefined rule.

The scheme of adding the field of a predefined bit size (e.g., 2 bits) to DCI format 0/4 according to this embodiment may be limitedly applied only when the corresponding DCI format is transmitted through a UE specific search space (USS).

### 2. Second Embodiment

According to a second embodiment of the present invention, in a situation in which UL HARQ reference configuration (or SIB1 information based UL-DL configuration) is set to UL-DL configuration #0, if DL HARQ reference configuration is set to one of UL-DL configurations #{2, 4, 5} (i.e., UL and DL HARQ reference configurations are set to different UL-DL configurations), a specific field (e.g., 2 bits) in DCI format 0/4 may be re(interpreted) based on at least one (i.e., a part or all) of the following Rule #A to Rule #H.

Rules according to this embodiment may be defined to be limitedly applied only when DCI format 0/4 is transmitted through a UE common search space (CSS). That is, when DCI format 0/4 is transmitted through a USS, the above-described first embodiment may be applied.

2.1. Rule #A

While interpretation of UL index information is applied to at least a part (i.e., some or all) of states related to a specific field of DCI format 0/4 in the same form as in a legacy system, UL DAI information may be configured to assume specific pre-configured (or signaled) value(s). For example, in 8.0 of 3GPP TS 36.213, which is an LTE standard document, the case in which Table 6 is applied is described among the contents defined in relation to a UL grant according to setting of UL index value or a PHICH based PUSCH transmission timeline.

TABLE 6
[CASE #A] For TDD UL/DL configuration 0 and normal HARQ operation the UE shall upon
detection of a PDCCH/EPDCCH with uplink DCI format and/or a PHICH transmission in subframe n
intended for the UE, adjust the corresponding PUSCH transmission in subframe n + k if the MSB of
the UL index in the PDCCH/EPDCCH with uplink DCI format is set to 1 or PHICH is received in
subframe n = 0 or 5 in the resource corresponding to I_{PHICH} = 0, as defined in clause 9.1.2 [1], with
k given in Table 8-2 [1].
[CASE #B] If, for TDD UL/DL configuration 0 and normal HARQ operation, the LSB of the UL index
in the DCI format 0/4 is set to 1 in subframe n or a PHICH is received in subframe n = 0 or 5 in the
resource corresponding to I_{PHICH} = 1, as defined in clause 9.1.2 [1], or PHICH is received in
subframe n = 1 or 6, the UE shall adjust the corresponding PUSCH transmission in subframe n + 7.
[CASE #C] If, for TDD UL/DL configuration 0, both the MSB and LSB of the UL index in the
PDCCH/EPDCCH with uplink DCI format are set in subframe n, the UE shall adjust the
corresponding PUSCH transmission in both subframes n + k and n + 7, with k given in Table 8-2 [1].

That is, the UL DAI information may be configured to assume specific preset (or signaled) value(s) while [CASE #A], [CASE #13] or [CASE #C] of Table 6 is applied (here, [CASE #C] corresponds to the case in which single UL DCI information (i.e., DCI format 0/4) schedules multiple (i.e., two) PUSCHs) in the same form as in the legacy LTE system.

In this case, interpretation of the UL index information is applied to at least a part (some or all) of states related to a specific field of DCI format 0/4 in the same form as in the legacy system, wherein i) UL DAI information configured (or signaled) per state or ii) UL DAI information configured (or signaled) per UL index information may be different in at least a part (i.e., some or all) thereof. Conversely, interpretation of the UL index information may be applied to at least a part (i.e., some or all) of states related to the specific field of DCI format 0/4 in the same form as in the a legacy system, wherein i) UL DAI information configured (or signaled) per state or ii) UL DAI information configured (or signaled) per UL index information may be the same in at least a part (i.e., some or all) thereof.

Specifically, if the size of the specific field is 2 bits, a total of 4 states is present and interpretation of the UL index information (e.g., [CASE #A], [CASE #B], or [CASE #C] of Table 6) is applied to each state in the same form as in the legacy system, wherein the UL DAI information configured (or signaled) per state or the UL DAI information configured (or signaled) per UL index information may be one of i) “[00]→‘UL DAI=1’”, “[01]→‘UL DAI=2’”, “[10]→‘UL DAI=3’”, and “[11]→‘UL DAI=4/0” (i.e., different UL DAI information is configured per state), ii) “[00]→‘UL DAI=2’”, “[01]→‘UL DAI=2’”, “[10]→‘UL DAI=2’”, and “[11]→‘UL DAI=2’” (i.e., the same UL DAI information is configured per state), and iii) “[00]→‘UL DAI=2’”, “[01]→‘UL DAI=2’”, “[10]→‘UL DAI=4/0’”, and “[11]→‘UL DAI=4/0’” (i.e., the same UL DAI information is configured with respect to some states) (in this case, ‘A→B’ means that case A indicates B). This example may be interpreted as representing that a value interpreted as the UL index information and a value interpreted as the UL DAI information are simultaneously mapped to one state related to the specific field (i.e., a 2-bit field used as a UL index/UL DAI) of DCI format 0/4.

As another example, if the size of the specific field is 2 bits, a total of 4 states is present and interpretation of the UL index information (e.g., [CASE #A], [CASE #B], or [CASE #C] of Table 6) is applied to each state in the same form as in the legacy system, wherein additionally configured UL DAI information may be (limitedly) designated only to states (e.g., [10], [01], and [11]) in which actually valid PUSCH transmission timeline information (or UL index information) is defined/mapped. The additionally configured UL DAI information may be one of i) “[01]→‘UL DAI=1’”, “[10]→‘UL DAI=2’”, and “[11]→‘UL DAI=4/0” (i.e., the case in which different UL DAI information is configured), ii) “[01]→‘UL DAI=2’”, “[10]→‘UL DAI=2’”, and “[11]→‘UL DAI=2’” (i.e., the case in which the same UL DAI information is configured), and iii) “[01]→‘UL DAI=2’”, “[10]→‘UL DAI=2’”, and “[11]→‘UL DAI=4/0’” (i.e., partially identical UL DAI information is configured) (in this case, ‘A→B’ means that case A indicates B).

2.2. Rule #B

While interpretation of the UL DAI information is applied to at least a part (i.e., a part or all) of states related to the specific field of DCI format 0/4 in the same form as in the legacy system, the UL index information may be configured to assume specific pre-configured (or signaled) value(s).

In this case, interpretation of the UL DAI information is applied to at least a part (some or all) of states related to the specific field of DCI format 0/4 in the same form as in the legacy system, wherein UL index information configured (or signaled) per state or UL index information configured (or signaled) per UL DAI information may be different in at least a part (i.e., some or all) thereof. Conversely, interpretation of UL DAI information may be applied to at least a part of states related to the specific field of DCI format 0/4 in the same form as in the legacy system, wherein UL index information configured (or signaled) per state or UL index information configured (or signaled) per UL DAI information may be the same in at least a part (i.e., some or all) thereof.

Specifically, if the size of the specific field is 2 bits, a total of 4 states is present and interpretation of the UL DAI information is applied to each state in the same form as the legacy system (i.e., “[00]→‘UL DAI=1’”, “[01]→‘UL DAI=2’”, “[10]→‘UL DAI=3’”, and “[11]→‘UL DAI=4”), wherein the UL index information configured (or signaled) per state or the UL index information configured (or signaler) per UL DAI information may be one of i) “[00]→‘UL index=[00]’”, “[01]→‘UL index=[01]’”, “[10]→‘UL index=[10]’”, and “[11]→‘UL index=[11]” (i.e., the case in which different UL index information is configured per state), ii) “[00]→‘UL index=[11]’”, “[01]→‘UL index=[11]’”, “[10]→‘UL index=[11]’”, and “[11]→‘UL index=[11]’” (i.e., the case in which the same UL index information is configured per state), and iii) “[00]→‘UL index=[10]’”, “[01]→‘UL index=[10]’”, “[10]→‘UL index=[11]’”, and “[11]→‘UL index=[11]’” (i.e., the same UL index information is configured in some states) (in this case, ‘A→B’ means that case A indicates B).

As another example, if the size of the specific field is 2 bits, a total of 4 states is present and interpretation of the UL DAI information is applied to each state in the same form as in the legacy system (i.e., “[00]→‘UL DAI=1’”, “[01]→‘UL DAI=2’”, “[10]→‘UL DAI=3’”, and “[11]→‘UL DAI=4”), wherein additionally configured UL index information may be (limitedly) designated only to states (e.g., [10], [01], and [11]) in which actually valid PUSCH transmission timeline information or UL index information is defined/mapped. For example, the additionally configured UL index information may be one of i) “[01]→‘UL index=[01]’”, “[10]→‘UL index=[10]’”, and “[11]→‘UL index=[11]” (i.e., the case in which different UL index information is configured), ii) “[01]→‘UL index=[11]’”, “[10]→‘UL index=[11]’”, and “[11]→‘UL index=[11]’” (i.e., the case in which the same UL index information is configured), and iii) “[01]→‘UL index=[10]’”, “[10]→‘UL index=[10]’”, and “[11]→‘UL index=[11]” (i.e., partially identical UL index information is configured) (in this case, ‘A→B’ means that case A indicates B).

As still another example, when Rule #A or Rule #B related to the second embodiment is applied, if the specific field is set to one state, a specific UL DAI value or specific UL DAI information corresponding thereto is assumed. Accordingly, a cell (or BS) may be configured to pre-transmit i) PDSCHs and/or ii) PDCCHs/EPDCCHs for indicating DL SPS release information of a number identical to the corresponding specific UL DAI value or specific UL DAI information within a predefined bundling window. That is, the total number of i) the PDSCHs and/or ii) the PDCCHs/EPDCCHs for indicating the DL SPS release information, received by the UE in the predefined bundling window, may be equal to the specific UL DAI value.

Furthermore, information about interpretation of at least a part (i.e., some or all) of states related to the specific field may be configured such that the BS informs the UE through a predefined signal (e.g., a physical layer signal or a higher layer signal) or may be configured to be implicitly recognized through a predefined rule.

2.3. Rule #C

Some of a plurality of states related to the specific field of DCI format 0/4 may be configured to be (re)interpreted as UL index information and the others may be configured to be (re)interpreted as UL DAI information.

As a detailed example, when the size of the specific field is 2 bits, a total of 4 states is present. In this case, [10], [01], and [11] may be configured to be interpreted as the UL index information in the same form as in the legacy system and may be configured to be interpreted as [CASE #A], [CASE #B], and [CASE #C], respectively (here, [CASE #C] corresponds to the case in which single UL DCI information (i.e., DCI format 0/4) schedules multiple (i.e., 2) PUSCHs. Meanwhile, [00] may be interpreted as the UL DAI information and may be configured to be interpreted as a predefined (or signaled) K value (e.g., 1 or 4/0). As another example, when the size of the specific field is 2 bits, a total of 4 states is present and [10] and [11] may be interpreted as the UL index information in the same form as in the legacy system and may be configured to be interpreted as [CASE #A] and [CASE #C] of Table 6, respectively. Meanwhile, [01] and [00] may be interpreted as the UL DAI information and may be configured to be interpreted as a predefined (or signaled) K value (e.g., 1) and an L value (e.g., 4/0), respectively. Further, information about interpretation of a state of the specific field may be configured such that the BS informs the UE through a predefined signal (e.g., a physical layer signal or a higher layer signal) or may be configured to be implicitly recognized through a predefined rule.

As a more detailed example of Rule #C, some bits (e.g., the first bit) of the specific field (i.e., a 2-bit field used as a UL index/UL DAI) of DCI format 0/4 may be used to designate PUSCH transmission SF (s) and other bits (e.g., the second bit) may be used to designate the number of DL SFs in which a PDSCH is received/the number of DL SFs in which a DL SPS release related (E)PDCCH is received.

Alternatively, for example, the first bit may be used to designate the number of DL SFs in which the PDSCH is received/the number of DL SFs in which the DL SPS release related (E)PDCCH is received and the second bit may be used to designate the PUSCH transmission SF(s).

2.3.1. Example #1 of Rule #C

If the value of the first bit is set to “0”, this may be interpreted (i.e., regarded as [CASE #C] of Table 6) such that the PUSCH is transmitted only in one UL SF (e.g., a UL SF for fixed usage or a UL SF in DL HARQ reference configuration) according to a HARQ timeline of UL HARQ reference configuration and, if the value of the first bit is set to “1”, this may be interpreted (i.e., regarded as [CASE #C] of Table 6) such that PUSCHs are transmitted in two UL SFs (e.g., a UL SF for fixed usage and a UL SF having changeable usage) according to the HARQ timeline of UL HARQ reference configuration.

2.3.2. Example #2 of Rule #C

If the value of the second bit is set to “0”, this may be interpreted as meaning that the number of DL SFs in which the PDSCH is received/the number of DL SFs in which the DL SPS release related (E)PDCCH is received is 0 (or a predefined (or signaled) value), in M SFs (in this case, M may be interpreted as i) an M value during i) bundling window size or channel selection table reference or iii) the maximum number of DL SFs linked with a specific UL SF) linked with a UL SF in which UL ACK/NACK transmission is performed for a DL SF in which a corresponding DCI format is received according to the HARQ timeline of DL HARQ reference configuration. (In this case, the DL SF in which the DCI format is received is included in the M SFs and all UL ACK/NACK signals for PDSCHs received in the M SFs are transmitted in a corresponding UL SF.)

If the value of the second bit is set to “1”, this may be interpreted as meaning that the number of DL SFs in which the PDSCH is received/the number of DL SFs in which the DL SPS release related (E)PDCCH is received is a predefined (or signaled) value, in M SFs linked with a UL SF in which UL ACK/NACK transmission is performed for a DL SF in which the DCI format is received according to the HARQ timeline of DL HARQ reference configuration. For example, if the value of the second bit is set to “1”, this may be interpreted as meaning that the number of DL SFs in which the PDSCH is received/the number of DL SFs in which the DL SPS release related (E)PDCCH is received is M which is a maximum value, in M SFs linked with a UL SF in which UL ACK/NACK transmission is performed for a DL SF in which the DCI format is received according to the HARQ timeline of DL HARQ reference configuration.

As a detailed example is given for the case in which SIB based UL-DL configuration is set to UL-DL configuration #0 (i.e., UL HARQ reference configuration), DL HARQ reference configuration is set to UL-DL configuration #2, and currently (re)configured usage change message (i.e., reconfiguration message) based UL-DL configuration is set to UL-DL configuration #1. In this case, if a DCI format is received in DL SF #1 and the value of the second bit is set to “1”, it may be assumed that the number of DL SFs in which the PDSCH is received/the number of DL SFs in which the DL SPS release related (E)PDCCH is received is 4, in 4 SFs (i.e., SFs #0, #1, #3, and #9) linked with a UL SF (i.e., UL SF #7) in which UL ACK/NACK transmission is performed for a DL SF in which the corresponding DCI format is received.

As another example, if the value of the second bit is set to “1”, this may be assumed to mean that the number of DL SFs in which the PDSCH is received/the number of DL SFs in which the DL SPS release related (E)PDCCH is received is a maximum number of SFs actually used for DL, in M SFs linked with a UL SF in which UL ACK/NACK transmission is performed for a DL SF in which the DCI format is received according to the HARQ timeline of DL HARQ reference configuration.

A detailed example is given for the case in which SIB based UL-DL configuration is set to UL-DL configuration #0 (i.e., UL HARQ reference configuration), DL HARQ reference configuration is set to UL-DL configuration #2, and currently (re)configured reconfiguration message based UL-DL configuration is set to UL-DL configuration #1. In this case; if a DCI format is received in DL SF#1 and the value of the second bit is set to “1”, it may be assumed that the number of DL SFs in which the PDSCH is received/the number of DL SFs in which the DL SPS release related (E)PDCCH is received is 3, in SFs (i.e., SFs #0, #1, and #9) which are actually used for DL because a maximum of 3 SFs (i.e., DL SFs #0, #1, and #9) is actually used for DL from among 4 SFs (i.e., SFs #0, #1, #3, and #9) linked with a UL SF (i.e., UL SF #7) in which UL ACK/NACK transmission is performed for a DL SF in which the corresponding DCI format is received.

As another example, if the value of the second bit is set to “1”, in M SFs linked with a UL SF in which UL ACK/NACK is performed for a DL SF in which the corresponding DCI format is received according to the HARQ timeline of DL HARQ reference configuration, the number of DL SFs in which the PDSCH is received/the number of DL SFs in which the DL SPS release related (E)PDCCH is received may be assumed only to be i) the number of previous SFs including (or excluding) a timing at which the corresponding DCI format (i.e., UL scheduling information) is received among the M SFs or ii) the number of previous SFs which includes (or excludes) a timing at which the corresponding DCI format (i.e., UL scheduling information) is received and, at the same time, are actually used for DL, among the M SFs.

2.3.3. Example #3 of Rule #C

If the value of the second bit is set to “1”, in M SFs linked with a UL SF in which UL ACK/NACK transmission is performed for a DL SF in which the corresponding DCI format is received according to the HARQ timeline of DL HARQ reference configuration, the number of DL SFs in which the PDSCH is received/the number of DL SFs in which the DL SPS release related (E)PDCCH is received may be configured to be differently applied according to setting of the first bit value (here, the DL SF in which the corresponding DCI format is received is included in the M SFs and all of UL ACK/NACK signals for PDSCHs received in the M SFs are transmitted through the corresponding UL SF).

For example, if the value of the first bit is set to “0” (e.g., a PUSCH is transmitted only in one UL SF of fixed usage according to the HARQ timeline of UL HARQ reference configuration), the number of DL SFs in which the PDSCH is received/the number of DL SFs in which the DL SPS release related (E)PDCCH is received, in M SFs linked to a UL SF in which UL ACK/NACK transmission is performed for a DL SF in which the corresponding DCI format is received, may be assumed to be M which is a maximum value.

On the other hand, if the value of the first bit is set to “1” (e.g., the case in which PUSCHs are transmitted in two UL SFs (e.g., a UL SF having fixed usage and a UL SF having changeable usage) according to the HARQ timeline of UL HARQ reference configuration), the number of DL SFs in which the PDSCH is transmitted/the number of DL SFs in which the DL SPS release related (E)PDCCH is received, in M SFs linked to a UL SF in which UL ACK/NACK transmission is performed for a DL SF in which the corresponding DCI format is received, may be assumed to be the maximum value of SFs actually used for DL.

2.3.4. Example #4 of Rule #C

As an embodiment to which at least one of Example #1 to Example #3 of Rule #C is applied, it is assumed that the specific field (i.e., the 2-bit field used as the UL index/UL DAI) in DCI format 0/4 is set to “[10]”.

In this case, the UE transmits PUSCHs (i.e., a similar operation to [CASE #C] of Table 6) in two UL SFs (e.g., a UL SF having fixed usage and a UL SF having changeable usage) according to the HARQ timeline of UL HARQ reference configuration.

In M SFs linked with a UL SF in which UL ACK/NACK transmission is performed for a DL SF in which the corresponding DCI format is received according to the HARQ timeline of DL HARQ reference configuration (here, the DL SF in which the corresponding DCI format is received is included in the M SFs and all of UL ACK/NACK signals for PDSCHs received in the M SFs are transmitted in a corresponding UL SF), the number of DL SFs in which the PDSCH is received/the number of DL SFs in which the DL SPS release related (E)PDCCH is received is regarded as 0 (or a predefined (or signaled) value) and UL ACK/NACK information for the DL SFs is piggybacked on the first transmitted PUSCH. Alternatively, the UL ACK/NACK information for the DL SFs may not be piggybacked on the first transmitted. UL data channel (e.g., this operation may be effective when the number of DL SFs in which the PDSCH is received/the number of DL SFs in which the DL SPS release related (E)PDCCH is received is regarded as 0).

As another embodiment, it is assumed that the specific field (i.e., the 2-bit field used as the UL index/UL DAI) of DCI format 0/4 is set to “[11]”.

In this case, the UE transmits PUSCHs (i.e., a similar operation to [CASE #C] of Table 6) in two UL SFs (e.g., a UL SF having fixed usage and a UL SF having changeable usage) according to the HARQ timeline of UL HARQ reference configuration.

In M SFs linked with a UL SF in which UL ACK/NACK transmission is performed for a DL SF in which the corresponding DCI format is received according to the HARQ timeline of DL HARQ reference configuration, the number of DL SFs in which the PDSCH is received/the number of DL SFs in which the DL SPS release related (E)PDCCH is received is regarded as M which is a maximum value and UL ACK/NACK information for the DL SFs is piggybacked on the first transmitted UL data channel.

As still another embodiment, it is assumed that the specific field (i.e., the 2-bit field used as the UL index/UL DAI) of DCI format 0/4 is set to “[01]”.

In this case, the UE transmits a PUSCH only in one UL SF (e.g., a UL SF for fixed usage or a UL SF for DL HARQ reference configuration) according to the HARQ timeline of UL HARQ reference configuration (i.e., operation similar to either [CASE #A] or [CASE #B] of Table 6).

In M SFs linked with a UL SF in which UL ACK/NACK transmission is performed for a DL SF in which the corresponding DCI format is received according to the HARQ timeline of DL HARQ reference configuration, the number of DL SFs in which the PDSCH is received/the number of DL SFs in which the DL SPS release related (E)PDCCH is received is regarded as M corresponding to a maximum value and UL ACK/NACK information for the DL SFs is piggybacked on the first transmitted PUSCH.

The above-described embodiments may be regarded as the case in which interpretation as UL index information and interpretation as UL DAI information are all (or simultaneously) mapped to one state related to the specific field (i.e., the 2-bit field used as the UL index/UL DAI) of DCI format 0/4.

2.4. Rule #D

The specific field (i.e., the 2-bit field used as the UL index/UL DAI) of DCI format 0/4 may be configured to differently interpret usage thereof according to a DL SF location at which DCI format 0/4 is transmitted.

As an example, in a situation in which UL HARQ reference configuration (or SIB1 information based UL-DL configuration) is set to UL-DL configuration #0, PUSCH transmission related scheduling information (i.e., DCI format 0/4) may be transmitted in DL SFs #0, #1, #5, and #6.

In this example, among the DL SFs (i.e., DL SFs #0, #1, #5, and #6) in which UL scheduling information is transmitted, the specific field of DCI format 0/4 transmitted in specific DL SFs (e.g., DL SFs #0 and #5) may be configured to be (re)interpreted as UL index information and the specific field of DCI format 0/4 transmitted in the other DL SFs (e.g., DL SFs #1 and #6) may be configured to be (re)interpreted as UL DAI information (in this case, for example, it is assumed that a UL index value in SFs #1 and #6 used as a UL DAI may be a specific value (e.g., ‘01’ (i.e., [CASE #B] of Table 6)) by [Rule #B].

As another proposed method, some (or all) states defined from the specific field (i.e., the 2-bit field used as the UL index/UL DAI) of DCI format 0/4 may be configured to be differently interpreted according to a DL SF location at which DCI format 0/4 is transmitted.

As an example, in a situation in which UL HARQ reference configuration (or SIB1 information based UL-DL configuration) is set to UL-DL configuration #0, at least a part (i.e., some or all) of states related to the specific field of DCI format 0/4 (i.e., the 2-bit field used as the UL index/UL DAI) transmitted in specific DL SFs (e.g., DL SFs #0 and #5) among DL SFs (i.e., DL SFs #0, #1, #5, and #6) in which UL scheduling information is transmitted may be configured to be (re)interpreted as the UL index information (e.g., “[01], [10], and [11] are interpreted as the UL index information”) and at least a part (i.e., some or all) of states related to the specific field of DCI format 0/4 transmitted in the other DL SFs (e.g., DL SFs #1 and #6) may be configured to be (re)interpreted as the UL DAI information (e.g., “[01], [10], and [11] are interpreted as the UL index information and [00] is interpreted as the UL DAI information” or “[01], [10], [11] (and [00]) are interpreted as the UL DAI information).

Further, in Rule #D, the BS may inform the UE of information about interpretation of usage of the specific field of DCI format 0/4 according to a DL SF location or information about interpretation of least a part (i.e., some or all) of states defined from the specific field of DCI format 0/4 through a predefined signal (e.g., a physical layer signal or a higher layer signal).

Hereinafter, a detailed embodiment of the case in which usage of the specific field (i.e., the 2-bit field used as the UL index/UL DAI) of DCI format 0/4 is differently interpreted according to a DL SF location at which corresponding DCI format 0/4 is transmitted according to Rule #D will be described.

If UL HARQ reference configuration (or SIB1 information based UL-DL configuration) is given as UL/DL configuration 0, a DL SF or special SF location at which scheduling information for a PUSCH in each UL SF is transmitted is given as follows.
UL SF #2→UL grant in SF #5 or #6
UL SF #3→UL grant in SF #6
UL SF #4→UL grant in SF #0
UL SF #7→UL grant in SF #0 or #1
UL SF #8→UL grant in SF #1
UL SF #9→UL grant in SF #5

Meanwhile, a UL DAI corresponds to a field necessary only when a PUSCH reported together with HARQ-ACK is scheduled. That is, that the UL DAI is needed in a specific UL grant is limited only when the UE transmits HARQ-ACK in a UL SF that the UL grant schedules.

To stably transmit HARQ-ACK in a situation in which UL-DL configuration is dynamically changed, DL HARQ reference configuration for defining a HARQ-ACK transmission timing may be additionally designated. Desirably, this DL HARQ reference configuration includes more DL SFs than UL SFs and the UL SFs in DL HARQ reference configuration are always used for UL without being changed to DL and used for HARQ-ACK transmission.

Assuming that UL-DL configuration including one or two UL SFs in one radio frame is used for DL HARQ reference configuration, UL-DL configurations #2, #4, and #5 may be used. A HARQ-ACK transmission timing for each case is considered as follows.
DL HARQ reference configuration #2: HARQ-ACK is transmitted in UL SFs #2 and #7. Assuming that the above-described UL HARQ reference configuration is set to UL-DL configuration 0, when the UL grant is transmitted in SFs #5, #6, #0, and #1, the UL grant schedules UL SFs #2 and #7. These SFs correspond to all DL and special SFs in UL HARQ reference configuration.
DL HARQ reference configuration #4: HARQ-ACK is transmitted in UL SFs #2 and #3. Assuming that the above-described UL HARQ reference configuration is set to UL-DL configuration 0, when the UL grant is transmitted in SFs #5 and #6, the UL grant schedules UL SFs #2 and #3. This means that the UL DAI is not necessary in SFs #0 and #1.
DL HARQ reference configuration #5: HARQ-ACK is transmitted in UL SF #2. Assuming that the above-described UL HARQ reference configuration is set to UL-DL configuration 0, when the UL grant is transmitted in SFs #5 and #6, the UL grant schedules UL SF #2. This means that the UL DAI is not necessary in SFs #0 and #1.

Consequently, in UL HARQ reference configuration 0 and DL HARQ reference configuration 4 or 5, SFs #0 and #1 may be used for the UL index and SFs #5 and #6 may be used for the UL DAI.

If an SF is used for the UL DAI, SFs #5 and #6 may be defined to schedule a PUSCH of only SFs #2 and #3, respectively (here, in SFs #5 and #6 used for the UL DAI, a UL index value may be interpreted as ‘01’ (i.e., [CASE #B] of Table 6)). In this case, it is impossible to schedule a PUSCH of SF #9 using the UL grant. However, an influence on scheduling restriction of SF #9 is weak because SF #9 is used as a DL SF in all UL-DL configurations except for UL-DL configuration #0. In addition, SF #9 may be used for retransmission without the UL grant using a PHICH.

If a problem related to PUSCH scheduling incapability in SF #9 is seriously regarded, an eNB may determine whether two bits in a specific SF are to be interpreted as a UL index or a UL DAI through a higher layer signal such as an RRC signal.

That is, whether a specific bit field of DCI format 0 or 4 is to be interpreted as the UL index or the UL DAI may be associated with not only an SF in which a corresponding DCI format is transmitted but also DL HARQ reference configuration. In addition, the eNB may adjust interpretation of any SF through a higher layer signal such as an RRC signal.

As another example, when a specific bit field of DCI format 0 or 4 transmitted at a specific DL SF location is interpreted as the UL DAI, UL DAI signaling at timings other than a timing at which the UL grant for scheduling a PUSCH in a UL SF (i.e., a static UL SF) in pre-configured DL reference UL-DL configuration (DL reference configuration) is received may be unnecessary. That is, the UL DAI corresponds to a valid field when a PUSCH reported together with HARQ-ACK is scheduled (here, a reception timing of the UL grant is determined by UL reference UL-DL configuration (UL reference configuration) or UL-DL configuration in an SIB).

Accordingly, a UL grant which is transmitted at timings other than a timing at which a UL grant for scheduling PUSCH transmission in a UL SF in DL reference UL-DL configuration may not signal the UL DAI and a UL DAI field in the UL grant may be set (or zero-padded) to a specific predefined (or signaled) value.

For example, the UL DAI (field value) set (or zero-padded) to a specific predefined (or signaled) value may be used for a virtual CRC. Specifically, if UL reference UL-DL configuration and DL reference UL-DL configuration are set to UL-DL configuration 6 and UL-DL configuration 5, respectively, and a specific bit field of DCI format 0 or 4 is interpreted as the UL DAI, the UL DAI in SFs ((i.e., SFs #0, #1, #6, and #9) other than SF #5 in which the UL grant for scheduling a PUSCH in UL SF #2 (or UL SF #12) in DL reference UL-DL configuration is received may be set (or zero-padded) to a specific predefined (or signaled) value.

This example may be extensively applied to at least one of i) the case in which usage of a specific bit field of DCI format 0 or 4 is determined by UL reference UL-DL configuration (e.g., the specific bit field of DCI format 0 or 4 is interpreted as a UL index only when UL reference UL-DL configuration is set to UL-DL configuration 0 and the specific bit field of DCI format 0 or 4 is interpreted as a UL DAI when UL reference UL-DL configuration is set to (other) UL-DL configurations except for UL-DL configuration 0), ii) the case in which usage of the specific bit field of DCI format 0 or 4 is differently configured according to a DL SF location (e.g., the specific bit field is interpreted as the UL index in SFs #0 and #1 and as the UL DAI in SFs #5 and #6), and iii) the case in which whether the specific bit field is to be interpreted as the UL index or the UL DAI is associated with not only an SF in which a corresponding DCI format is transmitted but also DL HARQ reference configuration.

In addition, the above example may be configured to be limitedly applied only when i) the UL DAI is defined as V_UL DAI (i.e., in a single-cell environment, HARQ-ACK bundling and PUCCH Format 1b with channel selection with Rel-8/10 mapping tables are configured) or ii) the UL DAI is defined as W_UL DAI (i.e., in a single-cell environment, PUCCH format 3 is configured or, in a CA environment, PUCCH format 1b with channel selection with Rel-10 mapping table or PUCCH format 3 is configured).

As another example, although the specific bit field of DCI format 0 or 4 transmitted at a specific DL SF location is interpreted as the UL DAI, when a scheme of “The number of HARQ-ACK bits for transmission on PUSCH can be determined by the size of the bundling window (i.e., M) for the DL HARQ timing reference configuration” is applied, the UL DAI is meaningless in actuality.

Therefore, the UL DAI in this case may not be signaled and a UL DAI field in the UL grant may be set (or zero-padded) to a specific predefined (or signaled) value.

For example, the UL DAI (field value) set (or zero-padded) to a specific predefined (or signaled) value may be used for a virtual CRC. In this case, the UE may configure HARQ-ACK information corresponding to M and piggyback the HARQ-ACK information on a PUSCH upon receiving at least one PDSCH or DL SPS release in one bundling window and may omit the ARQ-ACK configuration operation and the piggyback operation on the PUSCH in the other cases (i.e., upon receiving no PDSCH or DL SPS release).

In addition, this example may be configured to be limitedly applied only when i) the UL DAI is defined as V_UL DAI (i.e., in a single-cell environment, HARQ-ACK bundling and PUCCH Format 1b with channel selection with Rel-8/10 mapping tables are configured) or ii) the UL DAI is defined as W_UL DAI (i.e., in a single-cell environment, PUCCH format 3 is configured or, in a CA environment, PUCCH format 1b with channel selection with Rel-10 mapping table or PUCCH format 3 is configured).

2.5. Rule #E

Interpretation of usage of the specific field (i.e., the 2-bit field used as the UL index/UL DAI) of DCI format 0/4 may be configured to be differently performed according to i) a setting value of the specific field, ii) an SF timing at which PHICH information transmitted at the same timing as DCI format 0/4 is transmitted, and/or iii) a setting value of I_{PHICH} of the PHICH information transmitted at the same timing as DCI format 0/4. In 3GPP TS 36.213 which is an LTE standard document, I_{PHICH} is defined as 1 for TDD UL-DL configuration 0 and PUSCH transmission of SF n=4 or 9 and as 0 for the other cases.

For example, if the specific field (i.e., the 2-bit field used as the UL index/UL DAI) of DCI format 0/4 is set to a value of “[11]”, it may be assumed that the specific field is used as UL Index information and the specific field may be operated according to [CASE #C] of Table 6 (i.e., single UL scheduling information (UL grant) defines two PUSCHs transmitted at different timings).

Meanwhile, i) if the specific field (i.e., the 2-bit field used as the UL index/UL DAI) of DCI format 0/4 is set to at least a part (i.e., some or all) of values enumerated below, ii) PHICH information transmitted at the same timing as DCI format 0/4 is transmitted at at least a part (i.e., some or all) of timings enumerated below, and/or iii) the value of I_{PHICH} of the PHICH information transmitted at the same timing as DCI format 0/4 is set to a part (or all) of values enumerated below, an operation may be performed under the assumption that the specific field is used as the UL DAI information.
(1) The case in which the MSB of the specific field (i.e., the 2-bit field used as the UL index/UL DAI) of DCI format 0/4 is set to 1 (e.g., [10])
(2) The case in which the LSB of the specific field (i.e., the 2-bit field used as the UL index/UL DAI) of DCI format 0/4 is set to 1 (e.g., [01])
(3) The case in which PHICH information set to ‘I_{PHICH}=0’ is received in DL SF#0 or DL SF #5
(4) The case in which PHICH information set to ‘I_{PHICH}=1’ is received in DL SF#0 or DL SF #5
(5) The case in which PHICH information is received in DL SF#1 or DL SF #6

According to the above-described cases, DAI values linked to at least a part (i.e., some or all) of states defined in the specific field may be differently defined. Accordingly, a UL resource can be managed/scheduled efficiently (or with relatively large amount) by applying Rule #E in the case of high UL overhead (i.e., heavy UL traffic) in an environment in which usage of a radio resource is dynamically changed.

As another method, interpretation of at least a part (i.e., some or all) of states defined from the specific field (i.e., the 2-bit field used as the UL index/UL DAI) of DCI format 0/4 may be configured to be differently performed according to i) a setting value of the specific field, ii) an SF timing at which PHICH information transmitted at the same timing as DCI format 0/4 is transmitted, and/or iii) a setting value of I_{PHICH} of PHICH information transmitted at the same timing as DCI format 0/4.

For example, in a situation in which UL HARQ reference configuration (or SIB1 information based UL-DL configuration) is set to UL-DL configuration #0, if i) PHICH information (transmitted in the same timing as DCI format 0/4) set to ‘I_{PHICH}=0’ is received in DL SF#0 or DL SF #5 and/or ii) PHICH information (transmitted at the same timing as DCI format 0/4) set to ‘I_{PHICH}=1’ is received in DL SF#0 or DL SF #5, at least a part (i.e., some or all) of states related to the specific field (i.e., the 2-bit field used as the UL index/UL DAI) of DCI format 0/4 may be configured to be (re)interpreted as UL DAI information (e.g., “[01], [10], and [11] are interpreted as the UL index information and [00] is interpreted as the UL DAI information” or “[01], [10], [11] (, and [00]) are interpreted as the UL DAI information”). In contrast, in the other enumerated cases (e.g., cases (3), (4), and (5)), states related to the specific field of DCI format 0/4 may be configured to be (re)interpreted as the UL index information (e.g., “[01], [10], and [11] are interpreted as the UL index information and [00] is interpreted as the UL DAI information” or “[01], [10], and [11] are interpreted as the UL index information”).

In this Rule #E, according to at least one of i) a setting value of the specific field (i.e., the 2-bit field used as the UL index/UL DAI) of DCI format 0/4, ii) an SF timing at which PHICH information (transmitted at the same timing as DCI format 0/4), and iii) a setting value of I_{PHICH} of the PHICH information (transmitted at the same timing as DCI format 0/4), the BS may inform the UE of information about as which usage the specific field is (re)used or information about as which usage at least a part (i.e., some or all) of states defined from the specific field is (re)used through a predefined signal (e.g., a physical layer signal or a higher layer signal).

2.6. Rule #F

Interpretation of usage of the specific field (i.e., the 2-bit field used as the UL index/UL DAI) of DCI format 0/4 may be configured to be differently performed according to i) how many UL SFs are used when a corresponding DCI format received at a specific DL SF timing schedules PUSCHs transmitted therein upon operation according to a HARQ timeline of UL HARQ reference configuration (or a HARQ timeline of a HARQ timeline of SIB1 information based UL-DL configuration) or ii) how much PHICH information (about (previous) PUSCHs) is transmitted in a DL SF at which a corresponding DCI format is received upon operation according to the HARQ timeline of UL HARQ reference configuration (or the HARQ timeline of SIB1 information based UL-DL configuration).

For example, upon operation according to the HARQ timeline of UL HARQ reference configuration (or the HARQ timeline of SIB1 information based UL-DL configuration), when DCI format 0/4 received at a specific DL SF timing schedules PUSCHs transmitted in two UL SFs (or when the specific field of a corresponding DCI format (i.e., the 2-bit field used as the UL index/UL DAI) is set to “[11]”), the specific field of a corresponding DCI format (i.e., the 2-bit field used as the UL index/UL DAI) may be defined to be interpreted as UL index information. If DCI format 0/4 received at a specific DL SF timing schedules a PUSCH transmitted in one UL SF (or if the specific field of a corresponding DCI format (i.e., the 2-bit field used as the UL index/UL DAI) is set to “[01], [10] (, or [00])”), the specific field of the DCI format (i.e., the 2-bit field used as the UL index/UL DAI) may be defined to be interpreted as UL DAI information. That is, in a situation in which UL HARQ reference configuration (or SIB1 information based UL-DL configuration) is set to UL-DL configuration #0, an assumption that the specific field (i.e., the 2-bit field used as the UL index/UL DAI) of DCI format 0/4 is used for the UL index may be applied.

In addition, interpretation of usage of the specific field (i.e., the 2-bit field used as the UL index/UL DAI) of DCI format 0/4 may be configured to be differently performed according to for how many DL SFs UL ACK/NACK information is simultaneously transmitted in a UL SF in which UL ACK/NACK transmission is performed for a DL SF in which a corresponding DCI format is received (i.e., in a UL SF in which UL ACK/NACK transmission is performed when a PDSCH is received in a DL SF in which a corresponding DCI format is received) upon operation according to a HARQ timeline of DL HARQ reference configuration.

2.7. Rule #G

When at least a part (i.e., some or all) of states related to the specific field of DCI format 0/4 are interpreted as UL index information (e.g., [CASE #A], [CASE #B], or [CASE #C] of Table 6 (here, [CASE #C] corresponds to the case in which single UL DCI information (i.e., DCI format 0/4) schedules multiple (i.e., 2) PUSCHs)), at least one of Methods G-1 and G-2 described below may be defined to be applied. Additionally, this rule may be extensively applied to examples of [Rule #C] (e.g., the case in which the second bit of the specific field (i.e., the 2-bit field used as the UL index/UL DAI) of DCI format 0/4 is set to 1).

2.7.1 Method G-1

It is assumed that an SF in which UL ACK/NACK transmission for a DL SF of a specific timing at which a DCI format based PDSCH is received is performed according to a HARQ timeline of DL HARQ reference configuration is UL SF#N.

If one PDSCH is received (or when a DL DAI set to a value of 1 or more is received) in M SFs linked to the UL SF#N, the UE may generate a UL ACK/NACK payload size (or the number of UL ACK/NACK signals) piggybacked on a PUSCH transmitted in UL SF#N in consideration of only the number of DL SFs except for SFs actually used as a UL SF (or a PUSCH (re)transmission SF) among the M SFs.

Such an operation may be identically applied when the specific field (i.e., the 2-bit field used as the UL index/UL DAI) of DCI format 0/4 is used as a UL index or when PUSCH (re)transmission is performed through a signal (e.g., PHICH or UL SPS) other than a UL grant.

In this case, the UE may determine the number of SFs actually used as UL SFs among the M SFs, through reception of a HARQ timeline based UL grant (or PHICH) of UL HARQ reference configuration, by judging through how many SFs among the M SFs PUSCH transmission is actually scheduled (or performed).

That is, even when the UE fails to receive a reconfiguration message, formation of a UL ACK/NACK payload size (or the number of UL ACK/NACK signals) can be efficiently guaranteed.

Specifically, in the M SFs linked with UL SF#N, if transmission of K PUSCHs is scheduled (or performed), the UE configures only (M−K) UL ACK/NACK signals (or UL ACK/NACK payload) to piggyback the ACK/NACK signals on a PUSCH transmitted in UL SF#N.

2.7.1 Method G-2

In the M SFs linked with UL SF#N in which UL ACK/NACK transmission is performed for a DL SF in which DCI format 0/4 (i.e., including UL scheduling information) is received according to a HARQ timeline of DL HARQ reference configuration, if a PDSCH is not received (or a DL DAI set to a value of 1 or more is not received), the UE does not piggyback UL ACK/NACK information on a PUSCH transmitted in UL SF#N.

2.8. Rule #H

If at least a part (i.e., some or all) of states related to a specific field of DCI format 0/4 is interpreted as UL index information (e.g., [CASE #A], [CASE #B], or [CASE #C] of Table 6) (here, [CASE #C] corresponds to the case in which single UL DCI information (i.e., DCI format 0/4) schedules multiple (i.e., 2) PUSCHs), at least a part (i.e., some or all) of methods proposed below may be defined to be applied. Additionally, this rule may be extensively applied even to examples of [Rule #C] (e.g., the case in which the second bit of the specific field of DCI format 0/4 (i.e., a 2-bit field used as a UL index/UL DAI) is set to 1).

For example, it is assumed that UL ACK/NACK transmission for a DL SF of a specific timing at which a DCI format based PDSCH is received is performed in UL SF#N according to a HARQ timeline of DL HARQ reference configuration and M SFs linked with UL SF#N (i.e., M SFs configured to perform UL ACK/NACK transmission in UL SF#N according to the HARQ timeline of DL HARQ reference configuration) are present.

If DCI format 0/4 (and/or PHICH) based PUSCH (re)transmission, received in a DL SF of a specific timing among the M SFs, is performed in UL SF#N according to a HARQ timeline of UL HARQ reference configuration, ACK/NACK bits for M SFs (i.e., ACK/NACK bundling window size M) may be configured and piggybacked on a PUSCH (re)transmitted in UL SF#N. Alternatively, if DCI format 0/4 (and/or PHICH) based PUSCH (re)transmission received in a DL SF of a specific timing among M SFs is performed in UL SF#N according to the HARQ timeline of UL HARQ reference configuration and at least one PDSCH is received (or a DL DAI set to a value of 1 or more is received) in the M SFs, ACK/NACK bits for the M SFs (i.e., ACK/NACK bundling window size M) are configured and piggybacked on a PUSCH (re)transmitted in UL SF#N.

In contrast, if DCI format 0/4 (and/or PHICH) based PUSCH (re)transmission received in a DL SF of a specific timing which does not belong to M SFs is performed in UL SF#N according to the HARQ timeline of UL HARQ reference configuration, ACK/NACK bits for the M SFs (i.e., ACK/NACK bundling window size M) may be configured and piggybacked on a PUSCH (re)transmitted in UL SF#N. If DCI format 0/4 (and/or PHICH) based PUSCH (re)transmission received in a DL SF of a specific timing which does not belong to M SFs is performed in UL SF#N according to the HARQ timeline of UL HARQ reference configuration and at least one PDSCH is received (or a DL DAI set to a value of 1 or more is received) in the M SFs, ACK/NACK bits for the M SFs (i.e., ACK/NACK bundling window size M) may be configured and piggybacked on a PUSCH (re)transmitted in UL SF#N.

However, some of the M SFs are not actually used for DL due to dynamic change of usage of radio resources and, in this situation, unconditional configuration of an ACK/NACK bit size for the M SFs (i.e., ACK/NACK bundling window size M) may be an excessive operation or an undesirable operation in terms of ACK/NACK transmission/reception performance.

Therefore, an ACK/NACK bit size piggybacked on a PUSCH (re)transmitted in UL SF#N may be determined according to at least one of Rule H-1 to Rule H-3 proposed below.

Rule H-1 to Rule H-3 may be configured to be limitedly applied only when i) UL HARQ reference configuration (or SIB based configuration) is set to UL-DL configuration #0, ii) the specific field (i.e., the 2-bit field used as the UL index/UL DAI) of DCI format 0/4 is used as UL index information, iii) a UL index field is set to 11 (i.e., one DCI format 0/4 simultaneously schedules PUSCHs (re)transmitted in two UL SFs), and/or iv) PUSCH (re) transmission is performed through a method (e.g., UL SPS or PHICH) other than DCI format 0/4 (i.e., UL grant).

In addition, Rule H-1 to Rule H-3 may be extensively applied according to the HARQ timeline of UL HARQ reference configuration, even when i) PUSCH (re)transmission is performed in one UL SF (i.e., UL SF#N) through one DCI format 0/4 (and/or a PHICH) received in a DL SF of a specific timing or ii) PUSCH (re) transmission is performed in two UL SFs (i.e., UL SF#N and another UL HARQ reference configuration based UL SF) through one DCI format 0/4 (and/or a PHICH) received in a DL SF of a specific timing, among the M SFs. In contrast, these Rules H-1 to H-3 may be extensively applied according to the HARQ timeline of UL HARQ reference configuration, even when i) PUSCH (re)transmission is performed in one UL SF (i.e., UL SF#N) through one DCI format 0/4 (and/or a PHICH) received in a DL SF of a specific timing or ii) PUSCH (re) transmission is performed in two UL SFs (i.e., UL SF#N and another UL HARQ reference configuration based UL SF) through one DCI format 0/4 (and/or a PHICH) received in a DL SF of a specific timing, which does not belong to the M SFs

2.8.1. Rule #H-1

Hereinafter, for convenience of description, it is assumed that a radio frame index in which the PUSCH is (re)transmitted is radio frame#X and, based on a preconfigured usage change period (reconfiguration period) T, it is assumed that a range, to which i) a currently updated UL-DL configuration, ii) updated UL-DL configuration applied to radio frame#X, and/or iii) updated UL-DL configuration applied to a radio frame in which information scheduling/indicating PUSCH (re)transmission in UL SF#N is received is applied, is “from radio frame#Q to radio frame#(Q+T/10−1)”. In this case, it is assumed that radio frame#X in which the PUSCH is (re)transmitted belongs to the range from radio frame#Q to radio frame#(Q+T/10−1).

Rule #H-1 causes a UE to infer/derive candidates of UL-DL configuration having a high probability of being currently applied according to at which UL SF locations DCI format 0/4 (or PHICH) that schedules/indicates PUSCH (re)transmission on which ACK/NACK bits are piggybacked in UL SF#N schedules/indicates PUSCH transmission.

More specifically, the UE may recognize all (valid) U-DL configuration candidates that a BS can configure, through preconfigured DL reference UL-DL configuration information and UL reference UL-DL configuration (i.e., SIB based UL-DL configuration) information. Based on this premise, according to at which UL SF locations DCI format 0/4 (or PHICH) schedules/indicates PUSCH transmission in all of the candidates, wherein the DCI format 0/4 schedules/indicates PUSCH (re)transmission on which ACK/NACK bits are piggybacked in UL SF#N, the eNB may narrow UL-DL configuration candidates having a high probability of being substantially reconfigured during an interval from radio frame#Q to radio frame#(Q+T/10−1).

In this case, UL-DL configuration candidates having a high probability of being substantially reconfigured by the eNB during the interval from radio frame#Q to radio frame#(Q+T/10−1), finally recognized by the UE, may be limited to UL-DL configuration that necessarily includes (one or multiple) UL SFs in which PUSCH (re)transmission is scheduled/indicated according to DCI format 0/4 (or PHICH) that schedules/indicates PUSCH (re)transmission on which ACK/NACK bits are piggybacked in UL SF#N.

The following Table 7 to Table 9 show UL-DL configuration candidates having a high probability of being substantially reconfigured by the eNB during the interval from radio frame#Q to radio frame#(Q+T/10−1) during which the UE can infer/derive the candidates, according to at which UL SF locations DCI format 0/4 (or PHICH) schedules/indicates PUSCH transmission, wherein the DCI format 0/4 schedules/indicates PUSCH (re)transmission on which ACK/NACK bits are piggybacked in UL SF#N, when UL-DL configuration (i.e., SIB based UL-DL configuration) is set to UL-DL configuration #0.

For the case not specified in Table 7 to Table 9, the size of ACK/NACK bits piggybacked on a PUSCH (re)transmitted in UL SF#N may be configured with respect to M SFs (i.e., ACK/NACK bundling window size M) for which ACK/NACK is configured to be transmitted in UL SF#N according to DL reference UL-DL configuration. UL-DL configuration candidates having a high probability of being substantially reconfigured by the eNB are different according to DL reference UL-DL configuration. The following description is given of the case in which PUSCHs are simultaneously transmitted in two UL SFs, respectively, through one DCI format 0/4 (and/or a PHICH) received in a DL SF of a specific timing (among M SFs or that does not belong to the M SFs) and UL SF#N on which the ACK/NACK bits are piggybacked corresponds to one of two UL SFs.

Table 7 to Table 9 show various examples of (re)configured UL-DL configuration candidates that the UE can infer.

TABLE 7
Case in which DL reference configuration is set to UL-DL configuration#2
(i.e., All candidates (re)configurable by eNB are “UL-DL CONFIGURATION = {#0, 1, 2, 6}”)

| | | | (Re)configured | |
|---|---|---|---|---|
| | | | UL-DL | |
| | UL | | configuration | |
| | index | PUSCH | candidates | |
| UL grant/PHICH | setting | transmission | inferable by | |
| reception timing | value | timing | UE | Additional description |
| SF#(10 · (X − 1) + 5) | 11 | SF#(10 · (X − 1) + 9), | 0 | Scheduling information for a |
| | | SF#(10 · X + 2) | | PUSCH (on which ACK/NACK |
| | | | | information is piggybacked) |
| | | | | transmitted in the third SF (i.e., |
| | | | | SF#(10 · X + 2)) of radio frame#X |
| | | | | may be interpreted as being |
| | | | | transmitted in the sixth SF (i.e., |
| | | | | SF#(10 · (X − 1) + 5)) of radio frame |
| | | | | #(X − 1) and the sixth SF (i.e., |
| | | | | SF#(10 · (X − 1) + 5)) belongs to a |
| | | | | (DL) SF set (i.e., bundling window |
| | | | | size) configured to transmit |
| | | | | ACK/NACK information in the |
| | | | | third SF (i.e., SF#(10 · X + 2)) of |
| | | | | radio frame#X. |
| SF#(10 · (X − 1) + 6) | 11 | SF#(10 · X + 2), | 0, 1, 6 | Scheduling information for a |
| | | SF#(10 · X + 3) | | PUSCH (on which ACK/NACK |
| | | | | information is piggybacked) |
| | | | | transmitted in the third SF (i.e., |
| | | | | SF#(10 · X + 2)) of radio frame#X |
| | | | | may be interpreted as being |
| | | | | transmitted in the seventh SF (i.e., |
| | | | | SF#(10 · (X − 1) + 6)) of radio frame |
| | | | | #(X − 1) and the seventh SF (i.e., |
| | | | | SF#(10 · (X − 1) + 6)) belongs to a |
| | | | | (DL) SF set (i.e., bundling window |
| | | | | size) configured to transmit |
| | | | | ACK/NACK information in the |
| | | | | third SF (i.e., SF#(10 · X + 2)) of |
| | | | | radio frame#X. |
| SF#(10 · X + 1) | 11 | SF#(10 · X + 7), | 0, 1, 6 | Scheduling information for a |
| | | SF#(10 · X + 8) | | PUSCH (on which ACK/NACK |
| | | | | information is piggybacked) |
| | | | | transmitted in the eighth SF (i.e., |
| | | | | SF#(10 · X + 7)) of radio frame#X |
| | | | | may be interpreted as being |
| | | | | transmitted in the second SF (i.e., |
| | | | | SF#(10 · (X − 1) + 1)) of radio frame |
| | | | | #(X − 1) and the second SF (i.e., |
| | | | | SF#(10 · (X − 1) + 1)) belongs to a |
| | | | | (DL) SF set (i.e., bundling window |
| | | | | size) configured to transmit |
| | | | | ACK/NACK information in the |
| | | | | eighth SF (i.e., SF#(10 · X + 7)) of |
| | | | | radio frame#X. |
| SF#(10 · X + 0) | 11 | SF#(10 · X + 4), | 0, 6 | Scheduling information for a |
| | | SF#(10 · X + 7) | | PUSCH (on which ACK/NACK |
| | | | | information is piggybacked) |
| | | | | transmitted in the eighth SF (i.e., |
| | | | | SF#(10 · X + 7)) of radio frame#X |
| | | | | may be interpreted as being |
| | | | | transmitted in the first SF (i.e., |
| | | | | SF#(10 · (X − 1) + 0)) of radio frame |
| | | | | #(X − 1) and the first SF (i.e., |
| | | | | SF#(10 · (X − 1) + 0)) belongs to a |
| | | | | (DL) SF set (i.e., bundling window |
| | | | | size) configured to transmit |
| | | | | ACK/NACK information in the |
| | | | | eighth SF (i.e., SF#(10 · X + 7)) of |
| | | | | radio frame#X. |

TABLE 8
Case in which DL reference configuration is set to UL-DL configuration#4
(i.e., All candidates (re)configurable by eNB are “UL-DL CONFIGURATION = {#0, 1, 3, 4, 6}”)

| | | | (Re)configured | |
|---|---|---|---|---|
| | | | UL-DL | |
| | UL | | configuration | |
| UL | index | PUSCH | candidates | |
| GRANT/PHICH | setting | transmission | inferable by | |
| reception timing | value | timing | UE | Additional description |
| SF#(10 · (X − 1) + 5) | 11 | SF#(10 · (X − 1) + 9), | 0 | Scheduling information for a |
| | | SF#(10 · X + 2) | | PUSCH (on which ACK/NACK |
| | | | | information is piggybacked) |
| | | | | transmitted in the third SF (i.e., |
| | | | | SF#(10 · X + 2)) of radio frame#X |
| | | | | may be interpreted as being |
| | | | | transmitted in the sixth SF (i.e., |
| | | | | SF#(10 · (X − 1) + 5)) of radio frame |
| | | | | #(X − 1) and the sixth SF (i.e., |
| | | | | SF#(10 · (X − 1) + 5)) belongs to a |
| | | | | (DL) SF set (i.e., bundling window |
| | | | | size) configured to transmit |
| | | | | ACK/NACK information in the |
| | | | | third SF (i.e., SF#(10 · X + 2)) of |
| | | | | radio frame#X. |

TABLE 9
Case in which DL reference configuration is set to UL-DL configuration#5
(i.e., All candidates (re)configurable by eNB are “UL-DL CONFIGURATION = {#0, 1, 2, 3, 4, 5, 6}”)

| | | | (Re)configured | |
|---|---|---|---|---|
| | | | UL-DL | |
| | UL | | configuration | |
| UL | index | PUSCH | candidates | |
| grant/PHICH | setting | transmission | inferable by | |
| reception timing | value | timing | UE | Additional description |
| SF#(10 · (X − 1) + 5) | 11 | SF#(10 · (X − 1) + 9), | 0 | Scheduling information for a |
| | | SF#(10 · X + 2) | | PUSCH (on which ACK/NACK |
| | | | | information is piggybacked) |
| | | | | transmitted in the third SF (i.e., |
| | | | | SF#(10 · X + 2)) of radio frame#X |
| | | | | may be interpreted as being |
| | | | | transmitted in the sixth SF (i.e., |
| | | | | SF#(10 · (X − 1) + 5)) of radio frame |
| | | | | #(X − 1) and the sixth SF (i.e., |
| | | | | SF#(10 · (X − 1) + 5)) belongs to a |
| | | | | (DL) SF set (i.e., bundling window |
| | | | | size) configured to transmit |
| | | | | ACK/NACK information in the |
| | | | | third SF (i.e., SF#(10 · X + 2)) of |
| | | | | radio frame#X. |
| SF#(10 · (X − 1) + 6) | 11 | SF#(10 · (X + 2), | 0, 1, 3, 4, 6 | Scheduling information for a |
| | | SF#(10 · X + 3) | | PUSCH (on which ACK/NACK |
| | | | | information is piggybacked) |
| | | | | transmitted in the third SF (i.e., |
| | | | | SF#(10 · X + 2)) of radio frame#X |
| | | | | may be interpreted as being |
| | | | | transmitted in the seventh SF (i.e., |
| | | | | SF#(10 · (X − 1) + 6)) of radio frame |
| | | | | #(X − 1) and the seventh SF (i.e., |
| | | | | SF#(10 · (X − 1) + 6)) belongs to a |
| | | | | (DL) SF set (i.e., bundling window |
| | | | | size) configured to transmit |
| | | | | ACK/NACK information in the |
| | | | | third SF (i.e., SF#(10 · X + 2)) of |
| | | | | radio frame#X. |

2.8.2. Rule #H-2

The size of ACK/NACK bits which are piggybacked on a PUSCH (re)transmitted in UL SF#N may be configured to be determined based on UL-DL configuration (i.e., corresponding to a super set of a DL SF set) including the most DL SFs among UL-DL configuration candidates having a high probability of being substantially reconfigured by the eNB, that can be inferred by the UE, during the interval from radio frame#Q to radio frame#(Q+T/10−1), through Tables 7 to 9 and Rule #H-1 rather than DL reference UL-DL configuration. The determined UL-DL configuration may be interpreted as UL-DL configuration including the most DL SFs while including a DL SF set (or location) of UL reference UL-DL configuration among UL-DL configuration candidates having a probability of being additionally reconfigured.

Rule #H-2 has an advantage of always reducing the size of ACK/NACK bits, with high reliability, piggybacked on a PUSCH, regardless of whether a reconfiguration message has been successfully received from the eNB.

For the cases not specified in Table 10, Table 11, and Table 12, the size of ACK/NACK bits piggybacked on a PUSCH (re)transmitted in UL SF#N may be configured with respect to M SFs (i.e., ACK/NACK bundling window size M) configured to transmit ACK/NACK in UL SF#N according to DL reference UL-DL configuration.

For example, in a situation in which DL reference UL-DL configuration and UL reference UL-DL configuration (i.e., SIB based UL-DL configuration) are set to UL-DL configuration #5 and UL-DL configuration #0, respectively, it is assumed that the UE receives, in DL SF #16, UL scheduling information (i.e., UL grant) having a UL index set to ‘11’ and transmits PUSCHs in UL SF #22 and UL SF #23, respectively, according to UL reference UL-DL configuration.

In this situation, the UE confirms UL-DL configuration candidates (i.e., UL-DL configurations #0, 1, 3, 4, and 6) having a high probability of being reconfigured by the eNB during the interval from radio frame#Q to radio frame#(Q+T/10−1) through Rule #H-1 and Table 9 and determines the size of ACK/NACK bits piggybacked on a PUSCH (re)transmitted in UL SF#22 (i.e., a timing at which ACK/NACK for SFs #9, #10, #11, #13, #14, #15, #16, #17, and #18 is transmitted according to DL reference UL-DL configuration) based on UL-DL configuration #4 (corresponding to a super set of a DL SF set) having the most DL SFs among the configuration candidates.

In other words, among SFs #9, #10, #11, #13, #14, #15, #16, #17, and #18 configured to transmit ACK/NACK in UL SF #22 according to UL-DL configuration #5 (i.e., DL reference UL-DL configuration), the UE determines the size of ACK/NACK bits piggybacked on a PUSCH (re)transmitted in UL SF#22 in consideration of only the number of SFs designated for actual DL SF usage, even in UL-DL configuration #4.

In this way, according to Rule #H-2, the UE configures ACK/NACK bits for 8 SFs (i.e., SFs #9, #10, #11, #14, #15, #16, #17, and #18) designated for actual DL SF usage, rather than ACK/NACK bits for 9 SFs based on UL-DL configuration #5 (i.e., DL reference UL-DL configuration) in UL SF #22 and piggybacks the configured ACK/NACK bits on a PUSCH (re)transmitted in UL SF #22.

Table 10 to Table 12 show UL-DL configuration (i.e., corresponding to a super set of a DL SF set) including the most DL SFs, among UL-DL configuration candidates having a high probability of being substantially reconfigured by the eNB, that can be inferred by the UE, during the interval from radio frame#Q to radio frame#(Q+T/10−1) through Table 7 to Table 9 and Rule #H-1.

In addition, the size of ACK/NACK bits piggybacked on a PUSCH (re)transmitted in UL SF#N may be configured to be determined based on a UL-DL configuration (i.e., corresponding to a super set of a UL SF set) including the fewest DL SFs, among UL-DL configuration candidates having a high probability of being substantially reconfigured by the eNB, that can be inferred by the UE, during the interval from radio frame#Q to radio frame#(Q+T/10−1) through Table 7 to Table 9 and Rule #H-1.

As an additional example, the determined UL-DL configuration may be interpreted as a UL-DL configuration including the most UL SFs while including a UL SF set (or location) of UL reference UL-DL configuration among UL-DL configuration candidates having a high probability of being reconfigured.

Table 10 to Table 12 show various examples of UL-DL configuration including the most DL SF among (re)configured UL-DL configuration candidates that is inferable by the UE.

TABLE 10
Case in which DL reference configuration set to UL-DL configuration#2
(i.e., All candidates (re)configurable by eNB are “UL-DL CONFIGURATION = {#0, 1, 2, 6}”)

| | | | (Re)configured | |
|---|---|---|---|---|
| | | | UL-DL | |
| | UL | | configuration | |
| UL | index | PUSCH | candidates | |
| GRANT/PHICH | setting | transmission | inferably by | |
| reception timing | value | timing | UE | Additional description |
| SF#(10 · (X − 1) + 5) | 11 | SF#(10 · (X − 1) + 9), | 0 | Scheduling information for a |
| | | SF#(10 · X + 2) | | PUSCH (on which ACK/NACK |
| | | | | information is piggybacked) |
| | | | | transmitted in the third SF (i.e., |
| | | | | SF#(10 · X + 2)) of radio frame#X |
| | | | | may be interpreted as being |
| | | | | transmitted in the sixth SF (i.e., |
| | | | | SF#(10 · (X − 1) + 5)) of radio frame |
| | | | | #(X − 1) and the sixth SF (i.e., |
| | | | | SF#(10 · (X − 1) + 5)) belongs to a |
| | | | | (DL) SF set (i.e., bundling window |
| | | | | size) configured to transmit |
| | | | | ACK/NACK information in the |
| | | | | third SF (i.e., SF#(10 · X + 2)) of |
| | | | | radio frame#X. |
| SF#(10 · (X − 1) + 6) | 11 | SF#(10 · X + 2), | 1 | Scheduling information for a |
| | | SF#(10 · X + 3) | | PUSCH (on which ACK/NACK |
| | | | | information is piggybacked) |
| | | | | transmitted in the third SF (i.e., |
| | | | | SF#(10 · X + 2)) of radio frame#X |
| | | | | may be interpreted as being |
| | | | | transmitted in the seventh SF (i.e., |
| | | | | SF#(10 · (X − 1) + 6)) of radio frame |
| | | | | #(X − 1) and the seventh SF (i.e., |
| | | | | SF#(10 · (X − 1) + 6)) belongs to a |
| | | | | (DL) SF set (i.e., bundling window |
| | | | | size) configured to transmit |
| | | | | ACK/NACK information in the |
| | | | | third SF (i.e., SF#(10 · X + 2)) of |
| | | | | radio frame#X. |
| SF#(10 · X + 1) | 11 | SF#(10 · X + 7), | 1 | Scheduling information for a |
| | | SF#(10 · X + 8) | | PUSCH (on which ACK/NACK |
| | | | | information is piggybacked) |
| | | | | transmitted in the eighth SF (i.e., |
| | | | | SF#(10 · X + 7)) of radio frame#X |
| | | | | may be interpreted as being |
| | | | | transmitted in the second SF (i.e., |
| | | | | SF#(10 · (X − 1) + 1)) of radio frame |
| | | | | #(X − 1) and the second SF (i.e., |
| | | | | SF#(10 · (X − 1) + 1)) belongs to a |
| | | | | (DL) SF set (i.e., bundling window |
| | | | | size) configured to transmit |
| | | | | ACK/NACK information in the |
| | | | | eighth SF (i.e., SF#(10 · X + 7)) of |
| | | | | radio frame#X. |
| SF#(10 · X + 0) | 11 | SF#(10 · X + 4), | 6 | Scheduling information for a |
| | | SF#(10 · X + 7) | | PUSCH (on which ACK/NACK |
| | | | | information is piggybacked) |
| | | | | transmitted in the eighth SF (i.e., |
| | | | | SF#(10 · X + 7)) of radio frame#X |
| | | | | may be interpreted as being |
| | | | | transmitted in the first SF (i.e., |
| | | | | SF#(10 · (X − 1) + 0)) of radio frame |
| | | | | #(X − 1) and the first SF (i.e., |
| | | | | SF#(10 · (X − 1) + 0)) belongs to a |
| | | | | (DL) SF set (i.e., bundling window |
| | | | | size) configured to transmit |
| | | | | ACK/NACK information in the |
| | | | | eighth SF (i.e., SF#(10 · X + 7)) of |
| | | | | radio frame#X. |

TABLE 11
Case in which DL reference configuration is set to UL-DL configuration#4
(i.e., All candidates (re)configurable by eNB are “UL-DL CONFIGURATION = {#0, 1, 3, 4, 6}”)

| | | | (Re)configured | |
|---|---|---|---|---|
| | | | UL-DL | |
| | UL | | configuration | |
| UL | index | PUSCH | candidates | |
| GRANT/PHICH | setting | transmission | inferably by | |
| reception timing | value | timing | UE | Additional description |
| SF#(10 · (X − 1) + 5) | 11 | SF#(10 · (X − 1) + 9), | 0 | Scheduling information for a |
| | | SL#(10 · X + 2) | | PUSCH (on which ACK/NACK |
| | | | | information is piggybacked) |
| | | | | transmitted in the third SF (i.e., |
| | | | | SF#(10 · X + 2)) of radio frame#X |
| | | | | may be interpreted as being |
| | | | | transmitted in the sixth SF (i.e., |
| | | | | SF#(10 · (X − 1) + 5)) of radio frame |
| | | | | #(X − 1) and the sixth SF (i.e., |
| | | | | SF#(10 · (X − 1) + 5)) belongs to a |
| | | | | (DL) SF set (i.e., bundling window |
| | | | | size) configured to transmit |
| | | | | ACK/NACK information in the |
| | | | | third SF (i.e., SF#(10 · X + 2)) of |
| | | | | radio frame#X. |

TABLE 12
Case in which DL reference configuration is set to UL-DL configuration#5
(i.e., All candidates (re)configurable by eNB are “UL-DL CONFIGURATION = {#0, 1, 2, 3, 4, 5, 6}”)

| | | | (Re)configured | |
|---|---|---|---|---|
| | | | UL-DL | |
| | UL | | configuration | |
| UL | index | PUSCH | candidates | |
| GRANT/PHICH | setting | transmission | inferably by | |
| reception timing | value | timing | UE | Additional description |
| SF#(10 · (X − 1) + 5) | 11 | SF#(10 · (X − 1) + 9), | 0 | Scheduling information for a |
| | | SF#(10 · X + 2) | | PUSCH (on which ACK/NACK |
| | | | | information is piggybacked) |
| | | | | transmitted in the third SF (i.e., |
| | | | | SF#(10 · X + 2)) of radio frame#X |
| | | | | may be interpreted as being |
| | | | | transmitted in the sixth SF (i.e., |
| | | | | SF#(10 · (X − 1) + 5)) of radio frame |
| | | | | #(X − 1) and the sixth SF (i.e., |
| | | | | SF#(10 · (X − 1) + 5)) belongs to a |
| | | | | (DL) SF set (i.e., bundling window |
| | | | | size) configured to transmit |
| | | | | ACK/NACK information in the |
| | | | | third SF (i.e., SF#(10 · X + 2)) of |
| | | | | radio frame#X. |
| SF#(10 · (X − 1) + 6) | 11 | SF#(10 · X + 2), | 4 | Scheduling information for a |
| | | SF#(10 · X + 3) | | PUSCH (on which ACK/NACK |
| | | | | information is piggybacked) |
| | | | | transmitted in the third SF (i.e., |
| | | | | SF#(10 · X + 2)) of radio frame#X |
| | | | | may be interpreted as being |
| | | | | transmitted in the seventh SF (i.e., |
| | | | | SF#(10 · (X − 1) + 6)) of radio frame |
| | | | | #(X − 1) and the seventh SF (i.e., |
| | | | | SF#(10 · (X − 1) + 6)) belongs to a |
| | | | | (DL) SF set (i.e., bundling window |
| | | | | size) configured to transmit |
| | | | | ACK/NACK information in the |
| | | | | third SF (i.e., SF#(10 · X + 2)) of |
| | | | | radio frame#X. |

2.8.3. Rule #H-3

Rule #H-1 and Rule #H-2 may be extensively applied when a plurality of cells (or CCs) is configured (or used) as a CA scheme and an eNB simultaneously informs a UE of reconfiguration message information (or reconfigured UL-DL configuration information) for a plurality of cells (or CCs) used as the CA scheme through a specific field (of one location or common locations) of a reconfiguration message (i.e., the reconfiguration message information received through the (one) specific field is simultaneously applied to a plurality of cells (or CCs)).

In other words, in this case, since UL-DL configurations of a plurality of cells (or CCs) are simultaneously (re)changed to the same UL-DL configuration, UL-DL configuration candidates having a high probability of being substantially reconfigured, derived through Rule #H-1 and Rule #H-2, may be identically assumed even in the remaining cells (or CCs) in terms of a specific cell (or CC). Then the size of ACK/NACK bits for a plurality of cells (or CCs) piggybacked on a PUSCH (re)transmitted in UL SF#N of a specific cell can be reduced (i.e., ACK/NACK bits of the same number per cell can be reduced).

### 3. Third Embodiment

According to a third embodiment of the present invention, in a situation in which UL HARQ reference configuration (or SIB1 information based UL-DL configuration) is set to UL-DL configuration #0, if DL HARQ reference configuration is set to one of UL-DL configurations #{2, 4, 5} (i.e., UL and DL HARQ reference configurations are set to different UL-DL configurations), interpretation of a specific field (e.g., a 2-bit field) of DCI format 0/4 may be different according to through which SS of a CSS or a USS DCI format 0/4 is transmitted/received.

Specifically, when DCI format 0/4 is transmitted/received through the CSS, the specific field (e.g., 2 bits) may be configured to be interpreted as UL index information and, if the DCI format 0/4 is transmitted/received through the USS, the specific field (e.g., 2 bits) may be configured to be interpreted as UL DAI information or vice versa.

In addition, when DCI format 0/4 is transmitted/received through the CSS, the specific field (e.g., 2 bits) may be configured to be interpreted according to one of the above-described [Rule #A] to [Rule #H] and, when the DCI format 0/4 is transmitted/received through the USS, the specific field (e.g., 2 bits) may be configured to be differently interpreted from the case in which the DCI format 0/4 is transmitted through the CSS.

Additionally, when DCI format 0/4 is transmitted/received through the CSS, the specific field (e.g., 2 bits) may be configured to be interpreted as the UL index information and may be configured to assume that i) UL DAI information per state (of the specific field) or ii) UL DAI information per UL index information is set to predefined (or signaled) values (e.g. different values or the same value).

### 4. Fourth Embodiment

In the above-described first to third embodiments, interpretation of the specific field of DCI format 0/4 (e.g., interpretation as a UL DAI information related field or interpretation as a UL index information related field) and/or interpretation of “assumption (e.g., one of the first to third embodiments)” linked with at least a part (i.e., some or all) of states related to the specific field may be configured to be differently performed according to a type of UL-DL configuration (re)configured by a reconfiguration message.

When UL-DL configuration #0 is (re)configured by the reconfiguration message, the specific field (i.e., 2 bits) of DCI format 0/4 may be interpreted as UL index information and, when UL-DL configurations other than UL-DL configuration #0 are (re)configured by the reconfiguration message, the specific field (i.e., 2 bits) of DCI format 0/4 may be interpreted as UL DAI information.

As another example, when UL-DL configuration #0 is (re)configured by the reconfiguration message, a state of “[01]” related to the specific field (i.e., 2 bits) of DCI format 0/4 may be interpreted as UL index=[01] and, when UL-DL configurations other than UL-DL configuration #0 are (re)configured by the reconfiguration message, a state of “[01]” related to the specific field (i.e., 2 bits) of DCI format 0/4 may be interpreted as UL index=[11].

The above-described embodiments of the present invention (i.e., the first embodiment to the fourth embodiment) may be extensively applied even when at least one of a plurality of UL-DL configurations for the UE, i.e., SIB1 information based UL-DL configuration (or RadioResourceConfigCommonSCell IE information based UL-DL configuration), DL HARQ reference configuration related UL-DL configuration, UL HARQ reference configuration related UL-DL configuration, and currently (re)configured UL-DL configuration, is designated as specific predefined UL-DL configuration (e.g., UL-DL configuration #0). If there is no configuration set to the specific predefined UL-DL configuration (e.g., UL-DL configuration #0) among the UL-DL configurations for the UE, the specific field (e.g., 2 bits) of DCI format 0/4 may be configured to be interpreted as UL DAI information (or UL index information) according to a predefined rule.

In the above-described embodiments of the present invention, a bundling window size related to the UL index information (and/or UL DAI information) may be defined according to DL HARQ reference configuration related UL-DL configuration, UL HARQ reference configuration related UL-DL configuration or SIB1 information based UL-DL configuration, or UL-DL configuration reconfigured by the reconfiguration message.

The above-described embodiments of the present invention may be configured to be limitedly applied only when i) a dynamic change operation of radio resource usage is configured, ii) a specific transmission mode (TM) is configured, iii) a specific UL-DL configuration is set, iv) a specific UL ACK/NACK transmission scheme (e.g., ACK/NACK bundling scheme, ACK/NACK multiplexing scheme, PUCCH format 1B scheme with channel selection, or PUCCH format 3 scheme) is configured, and/or v) UL ACK/NACK is transmitted only through a PUSCH (or PUCCH).

It is apparent that each of the above-described embodiments/rules/configurations of the present invention may be regarded as one independent invention and, further, may be carried out in the form of at least one combination or integration of the above-described embodiments of the present invention.

FIG. 15 illustrates a BS and a UE which are applicable to an embodiment of the present invention. If a wireless communication system includes a relay, communication on a backhaul link is performed between the BS and the relay and communication on an access link is performed between the relay and the UE. Accordingly, the BS and UE shown in the drawing may be replaced with the relay according to situation.

Referring to FIG. 15, a wireless communication system includes a BS 110 and a UE 120. The BS 110 includes a processor 112, a memory 114, and a radio frequency (RF) unit 116. The processor 112 may be configured to perform the proposed procedures and/or methods according to the present invention. The memory 114 is connected to the processor 112 and stores various types of information related to operations of the processor 112. The RF unit 116 is connected to the processor 112 and transmits and/or receives radio signals. The UE 120 includes a processor 122, a memory 124, and an RF unit 126. The processor 122 may be configured to perform the proposed procedures and/or methods according to the present invention. The memory 124 is connected to the processor 122 and stores various types of information related to operations of the processor 122. The RF unit 126 is connected to the processor 122 and transmits and/or receives radio signals. The BS 110 and/or the UE 120 may include a single antenna or multiple antennas.

The embodiments of the present invention described above are combinations of elements and features of the present invention in a predetermined form. The elements or features may be considered selective unless mentioned otherwise. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. It will be obvious to those skilled in the art that claims that are not explicitly cited in each other in the appended claims may be presented in combination as an embodiment of the present invention or included as a new claim by a subsequent amendment after the application is filed.

The embodiments of the present invention may be achieved by various means, for example, hardware, firmware, software, or a combination thereof. In a hardware configuration, the methods according to exemplary embodiments of the present invention may be achieved by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In a firmware or software configuration, an embodiment of the present invention may be implemented in the form of a module, a procedure, a function, etc. Software code may be stored in a memory unit and executed by a processor. The memory unit may be located at the interior or exterior of the processor and may transmit and receive data to and from the processor via various known means.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

### INDUSTRIAL APPLICABILITY

While the above-described method of transmitting and receiving a DL signal in a wireless communication system and the apparatus therefor have been described centering on an example applied to a 3GPP LTE system, the present invention is applicable to a variety of wireless communication systems in addition to the 3GPP LTE system.

1. A method of receiving a downlink signal of a user equipment (UE) in a time division duplex (TDD) wireless communication system supporting usage change of a radio resource, the method comprising:
setting a first uplink (UL)-downlink (DL) configuration and a second UL-DL configuration with respect to the UE; and
receiving DL control information including a specific field,
wherein the specific field is defined as an independent state with respect to each of the first UL-DL configuration and the second UL-DL configuration.

2. The method according to claim 1, wherein the specific field indicates a UL index with respect to the first UL-DL configuration and indicates a UL downlink assignment index (DAI) with respect to the second UL-DL configuration.

3. The method according to claim 1, wherein the specific field is determined as one of the UL index and the UL DAI according to a subframe location at which the DL control information is received.

4. The method according to claim 3, wherein the subframe location used to determine one of the UL index and the UL DAI is indicated through higher layer signaling.

5. The method according to claim 1, wherein the first UL-DL configuration is a UL hybrid automatic repeat and request (HARQ) reference configuration, the second UL-DL configuration is a DL HARQ reference configuration, and, in the second UL-DL configuration, a UL downlink assignment index (DAI) not received together with a UL grant of the DL HARQ reference configuration is set to a specific predefined value.

6. The method according to claim 5, wherein the specific value is defined as a virtual cyclic redundancy check (CRC).

7. The method according to claim 1, wherein the first UL-DL configuration is a UL HARQ reference configuration and the second UL-DL configuration is a DL HARQ reference configuration and wherein if the number of HARQ-acknowledgement (ACK) bits for physical uplink shared control channel (PUSCH) transmission is determined as a bundling window size for the DL HARQ reference configuration, HARQ-ACK information is transmitted through piggyback upon receiving a physical DL shared control channel (PUSCH) or a DL semi-persistent scheduling (SPS) release signal in the bundling window.

8. The method according to claim 1, wherein the DL control information is received together with a physical hybrid ARQ indicator channel (PHICH) and a state of the specific field is defined according to the PHICH.

9. The method according to claim 1, wherein the DL control information is received together with a physical hybrid ARQ indicator channel (PHICH) and a state of the specific field is defined according to the PHICH.

10. The method according to claim 1, wherein the specific field has a state defined according to a search space in which the DL control information is received.

11. A user equipment (UE) for receiving a downlink signal in a time division duplex (TDD) wireless communication system supporting usage change of a radio resource, the UE comprising:
a radio frequency unit; and
a processor,
wherein the processor is configured to set a first uplink (UL)-downlink (DL) configuration and a second UL-DL configuration and receive DL control information including a specific field, and
wherein the specific field is defined as an independent state with respect to each of the first UL-DL configuration and the second UL-DL configuration.
